(19) United States
(12) Patent Application Publication
(10) Pub. No.: US 2026/0050148 A1
(43) Pub. Date: Feb. 19, 2026

(54) OPTICAL SYSTEM, IMAGE PROJECTION APPARATUS, AND IMAGING APPARATUS

(71) Applicant: Panasonic Intellectual Property Management Co., Ltd., Osaka (JP)

(72) Inventors: Takuya IMAOKA, Kanagawa (JP); Yasushi KOBAYASHI, Osaka (JP)

(21) Appl. No.: 19/357,499

(22) Filed: Oct. 14, 2025

Related U.S. Application Data
(63) Continuation of application No. PCT/JP2024/015229, filed on Apr. 17, 2024.

(30) Foreign Application Priority Data
Jun. 13, 2023 (JP) 2023-097083
Nov. 22, 2023 (JP) 2023-198654

(51) Int. Cl. G02B 13/16; G02B 13/18; G02B 17/08; G02B 27/09; G03B 21/28

(52) U.S. Cl. CPC G02B 13/16; G02B 13/18; G02B 17/0856; G02B 27/0972; G03B 21/28

(57) ABSTRACT

An optical system has a reduction conjugate point on a reduction side and a magnification conjugate point on a magnification side, and has an intermediate imaging position conjugate with each of these points inside. The optical system includes: a first sub-optical system including a plurality of lenses arranged along an optical axis, and an aperture stop; and a second sub-optical system including a prism. The prism includes a first transmission surface located on the reduction side; a second transmission surface located on the magnification side; and a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface.

### CROSS REFERENCE TO RELATED APPLICATION

This application claims benefit of priority to International Application No. PCT/JP2024/015229, with an international filing date of Apr. 17, 2024, which claims priorities of Japanese Patent Application No. 2023-097083 filed on Jun. 13, 2023 and Japanese Patent Application No. 2023-198654 filed on Nov. 22, 2023, the entire contents of which are incorporated herein by reference.

### BACKGROUND

### Technical Field

The present disclosure relates to an optical system using a prism. The present disclosure also relates to an image projection apparatus and an imaging apparatus using such an optical system.

### Background Art

JP 2020-194115 A, JP 2021-117276 A and JP 2020-024377 A disclose an optical system that enables projection or imaging of a short focal and a large screen using a prism.

### SUMMARY

The present disclosure provides an optical system that enables oblique projection or imaging of a short focal and a large screen. The present disclosure also provides an image projection apparatus and an imaging apparatus using such an optical system.

An aspect of the present disclosure is an optical system having a reduction conjugate point on a reduction side and a magnification conjugate point on a magnification side, and having an intermediate imaging position conjugate with each of the reduction conjugate point and the magnification conjugate point inside, the optical system comprising:
a first sub-optical system including a plurality of lenses arranged along an optical axis in a Z direction, and an aperture stop between two lenses among the plurality of lenses; and
a second sub-optical system disposed closer to the magnification side than the first sub-optical system and including a prism having a plurality of optical surfaces, wherein
the prism includes: as the plurality of optical surfaces,
   a first transmission surface located on the reduction side;
   a second transmission surface located on the magnification side; and
   a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface,
a light flux travels in a YZ surface including the Z direction and the Y direction inside the prism,
the intermediate imaging position of a first light flux closest to the optical axis is disposed between the first transmission surface and the first reflection surface,
the second transmission surface has a shape with a convex surface facing the magnification side, and a reflection surface located on a most magnification side in the reflection surface group has a convex shape with respect to the inside of the prism,
the first reflection surface has stronger positive power than the second reflection surface, and
on the YZ surface with respect to an effective region of the plurality of optical surfaces,
a distance FL2 is smaller than a distance FL1 in the distance FL1 between a point of the first reflection surface farthest from a perpendicular line of the optical axis passing through a surface vertex of an optical surface on a most magnification side of the first sub-optical system and the perpendicular line and the distance FL2 between a point of the second transmission surface farthest from the perpendicular line and the perpendicular line.

Another aspect of the present disclosure is an optical system having a reduction conjugate point on a reduction side and a magnification conjugate point on a magnification side, the optical system having an intermediate imaging position conjugated with each of the reduction conjugate point and the magnification conjugate point inside, the optical system comprising:
a first sub-optical system including a plurality of lenses arranged along an optical axis in a Z direction, and an aperture stop between two lenses among the plurality of lenses; and
a second sub-optical system disposed closer to the magnification side than the first sub-optical system and including a prism having a plurality of optical surfaces, wherein
the prism includes: as the plurality of optical surfaces,
   a first transmission surface located on the reduction side,
   a second transmission surface located on the magnification side; and
   a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface,
a light flux travels in a YZ surface including the Z direction and the Y direction inside the prism,
the intermediate imaging position of a first light flux closest to the optical axis is disposed between the first transmission surface and the first reflection surface,
the second transmission surface has a shape with a convex surface facing the magnification side, and a reflection surface located on a most magnification side in the reflection surface group has a convex shape with respect to the inside of the prism,
the reduction conjugate point has a rectangular region having a first direction and a second direction, a plane surface including a position where a principal ray of the first light flux in the rectangular region reflects off the first reflection surface and the optical axis of the first sub-optical system is defined as a Y cross section, and a light flux farthest from the optical axis of the first sub-optical system on a line where the Y cross section and the rectangular region intersect is defined as a second light flux, a first footprint region of the first light flux overlaps a second footprint region of the second light flux on the second reflection surface.

Another aspect of the present disclosure is an image projection apparatus comprising: the optical system; and an image forming element configured to generate an image to be projected onto a screen via the optical system.

Another aspect of the present disclosure is an imaging apparatus comprising: the optical system; and an imaging element configured to receive an optical image formed by the optical system and convert the optical image into an electrical image signal.

According to the optical system according to the present disclosure, the prism can be easily manufactured, and the prism having a free-form surface can be downsized. In addition, oblique projection or imaging toward the magnification conjugate point becomes possible.

### BRIEF DESCRIPTION OF DRAWINGS

FIG. 1 is an arrangement diagram illustrating an optical system 1 according to a first example;

FIG. 2A is a perspective view illustrating a three-dimensional shape of each optical surface of a prism PM;

FIG. 2B illustrates a part of light rays traveling inside the prism PM;

FIG. 3A is a cross-sectional view of the prism PM along a YZ surface;

FIG. 3B illustrates a part of the light rays traveling inside the prism PM;

FIG. 4A is a top view of the prism PM viewed from the Y direction;

FIG. 4B illustrates a part of the light rays traveling inside the prism PM;

FIG. 5A is a YZ cross-sectional view for explaining definitions of a first point on a first transmission surface T1, a second point on a second reflection surface R2, and an incident angle of a light ray on the second reflection surface R2;

FIG. 5B is a YZ cross-sectional view for explaining the definitions of distances PL1 and PL2;

FIG. 6 is a lateral aberration diagram of the optical system 1 according to the first example;

FIG. 7 is an arrangement diagram illustrating the optical system 1 according to a second example;

FIG. 8 is a lateral aberration diagram of the optical system 1 according to the second example;

FIG. 9 is an arrangement diagram illustrating the optical system 1 according to a third example;

FIG. 10 is a lateral aberration diagram of the optical system 1 according to the third example;

FIG. 11A illustrates a state where an image projection apparatus 100 is installed on a lower surface of a ceiling CE;

FIG. 11B illustrates a state where the image projection apparatus 100 is installed on an upper surface of the ceiling CE;

FIG. 12A is a YZ cross-sectional view for explaining definitions of variables in formula (6);

FIG. 12B is a ZX cross-sectional view for explaining definitions of variables in formula (6);

FIG. 13 is an arrangement diagram illustrating the optical system 1 according to a fourth example;

FIG. 14A is a front perspective view illustrating a three-dimensional shape of each optical surface of the prism PM;

FIG. 14B is a rear perspective view illustrating a three-dimensional shape of each optical surface of the prism PM;

FIG. 14C is a side view illustrating a three-dimensional shape of the prism PM;

FIG. 15A is a side view illustrating relative positions of the first transmission surface T1, a second transmission surface T2, a first reflection surface R1, the second reflection surface R2, and a third reflection surface R3;

FIG. 15B is a side view illustrating a part of the light rays traveling inside the prism PM;

FIG. 16A is a top view illustrating relative positions of the first transmission surface T1, the second transmission surface T2, the first reflection surface R1, the second reflection surface R2, and the third reflection surface R3 viewed from the Y direction;

FIG. 16B is a top view illustrating a part of the light rays traveling inside the prism PM;

FIG. 17 is a YZ cross-sectional view illustrating a state in which a first light flux LF1 and a second light flux LF2 travel in order of the first transmission surface T1, the second transmission surface T2, the first reflection surface R1, the second reflection surface R2, and the third reflection surface R3;

FIGS. 18A and 18B are explanatory views illustrating a relationship between a first footprint region FP1 of the first light flux LF1 and a second footprint region FP2 of the second light flux LF2 on the second reflection surface R2;

FIG. 19 is an explanatory view illustrating a relationship between a third footprint region FP3 of the first light flux LF1 and a fourth footprint region FP4 of the second light flux LF2 on the third reflection surface R3;

FIG. 20 is a graph illustrating a second derivative value of a sag height change on a Y cross section on the first reflection surface R1;

FIG. 21 is a lateral aberration diagram of the optical system 1 according to a fourth example;

FIG. 22 is a lateral aberration diagram of the optical system 1 according to the fourth example;

FIG. 23 is a lateral aberration diagram of the optical system 1 according to the fourth example;

FIG. 24 is an arrangement diagram illustrating the optical system 1 according to a fifth example;

FIG. 25 is a lateral aberration diagram of the optical system 1 according to the fifth example;

FIG. 26 is a lateral aberration diagram of the optical system 1 according to the fifth example;

FIG. 27 is a lateral aberration diagram of the optical system 1 according to the fifth example;

FIG. 28 corresponds to FIG. 9 of the basic application (JP 2023-198654 A), and is an explanatory view illustrating the shapes of footprints on the first reflection surface R1 and the second reflection surface R2;

FIG. 29 is a block diagram illustrating an example of an image projection apparatus according to the present disclosure; and

FIG. 30 is a block diagram illustrating an example of an imaging apparatus according to the present disclosure.

### DETAILED DESCRIPTION

Hereinafter, embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that, the applicant provides the accompanying drawings and the following description for those skilled in the art to fully understand the present disclosure, and does not intend to limit the subject matter described in the claims by the accompanying drawings and the following description.

Hereinafter, each embodiment of the optical system according to the present disclosure will be described. In each embodiment, a case will be described where the optical system is used for a projector (an example of an image projection apparatus) that projects, onto a screen, image light of an original image SA obtained by spatially modulating incident light by an image forming element such as a liquid crystal or a digital micromirror device (DMD) based on an image signal. That is, the optical system according to the present disclosure can be used to dispose a screen (not illustrated) on the extension line on the magnification side, magnify the original image SA on the image forming element disposed on the reduction side, and project the magnified original image SA onto the screen. However, the projection target surface is not limited to the screen. The projection target surface also includes a wall, a ceiling, a floor, a window, and the like in a house, a store, or a vehicle or the inside of an air plane used for a mobile transportation means.

In addition, the optical system according to the present disclosure can also be used to collect light emitted from an object located on an extension line on the magnification side and form an optical image of the object on an imaging surface of an imaging element disposed on the reduction side.

### First Embodiment

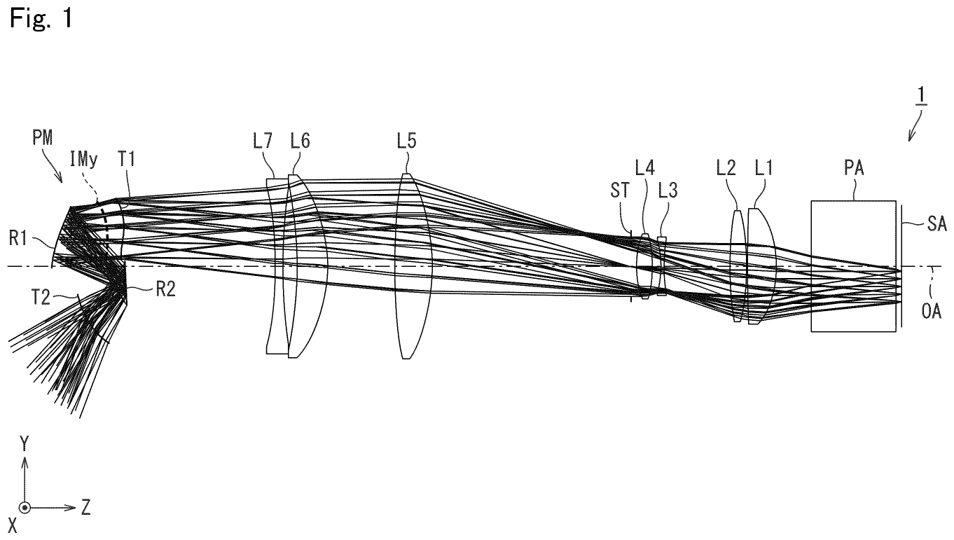

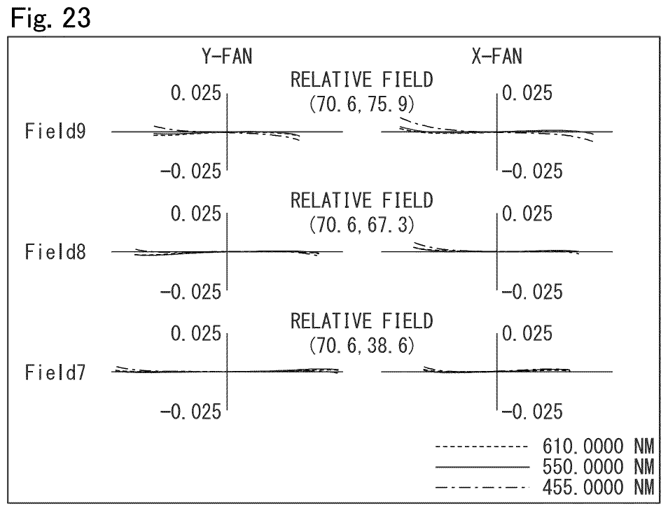

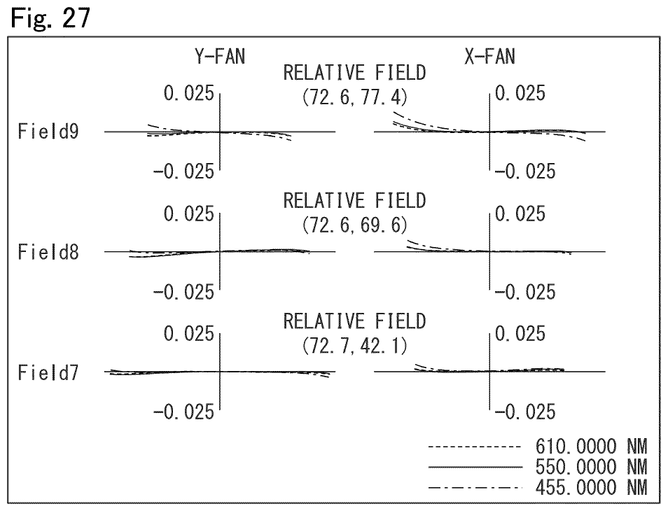

An optical system according to a first embodiment of the present disclosure will be described below with reference to FIGS. 1 to 28.

### First Example

FIG. 1 is an arrangement diagram illustrating an optical system 1 according to a first example. The optical system 1 includes a first sub-optical system including an aperture stop ST and a second sub-optical system including a prism PM. In FIG. 1, a reduction conjugate point which is an image forming position on the reduction side is located on the right side of an optical axis OA, and a magnification conjugate point which is an image forming position on the magnification side is located on the lower left side of the optical axis OA. The second sub-optical system is provided closer to the magnification side than the first sub-optical system.

In addition, an intermediate imaging position that is conjugated with each of the reduction conjugate point and the magnification conjugate point is located inside the optical system 1. In this intermediate imaging position, both a Y-direction intermediate image IMy and an X-direction intermediate image IMx exist inside the prism PM. The Y-direction intermediate image IMy is illustrated in FIG. 1, but the X-direction intermediate image IMx is not illustrated.

The first sub-optical system includes an optical element PA and lens elements L1 to L7 in order from the reduction side to the magnification side. The optical element PA represents an optical element such as a total internal reflection (TIR) prism, a prism for color separation and color synthesis, an optical filter, a parallel and flat plate glass, a crystal low-pass filter, and an infrared cut filter. The reduction conjugate point is set at a position at a predetermined distance from the end surface of the optical element PA on the reduction side, and the original image SA is installed therein (surface 23). Regarding the surface number, a numerical example to be described later is referred to.

The optical element PA has two parallel and flat transmission surfaces (surfaces 21 and 22). The lens element L1 has a biconvex shape (surfaces 19 and 20). The lens element L2 has a biconvex shape (surfaces 17 and 18). The lens element L3 has a biconcave shape (surfaces 15 and 16). The lens element L4 has a biconvex shape (surfaces 13 and 14). The lens element L5 has a biconvex shape (surfaces 9 and 10). The lens element L6 has a positive meniscus shape with a convex surface facing the reduction side (surfaces 7 and 8). The lens element L7 has a biconcave shape (surfaces 5 and 6). These lens elements L1 to L7 are rotationally symmetric lenses having a surface shape rotationally symmetric around the optical axis OA of the first sub-optical system, and a portion through which a light ray does not pass may be deleted as necessary.

The second sub-optical system includes the prism PM formed of a transparent medium, for example, glass, synthetic resin, or the like. The prism PM includes, as a plurality of optical surfaces, a first transmission surface T1 located on the reduction side, a second transmission surface T2 located on the magnification side, and a first reflection surface R1 and a second reflection surface R2 that are located on the optical path between the first transmission surface T1 and the second transmission surface T2. The first transmission surface T1 has a free-form surface shape with a convex surface facing the reduction side (surface 4). The first reflection surface R1 has a free-form surface shape with a concave surface facing a direction in which light rays incident on the first reflection surface R1 reflect (surface 3). The second reflection surface R2 has a free-form surface shape with a convex surface facing a direction in which light rays incident on the second reflection surface R2 reflect (surface 2). The second transmission surface T2 has a free-form surface shape with a convex surface facing the magnification side (surface 1).

The aperture stop ST defines a range in which a light flux passes through the optical system 1, and is positioned between the reduction conjugate point and the above-described intermediate imaging position. As an example, the aperture stop ST is located between the lens element L4 and the lens element L5 (surface 12).

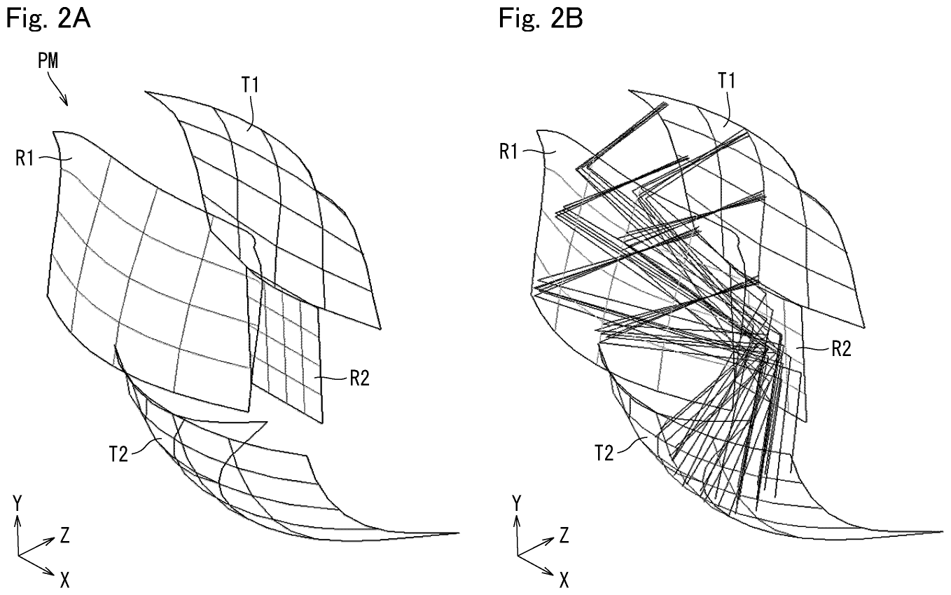

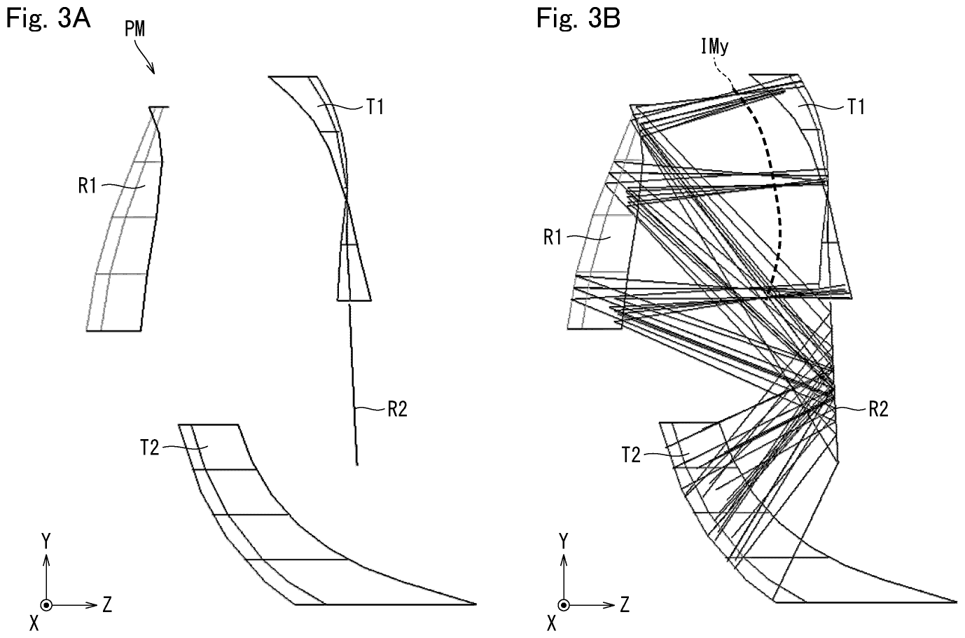

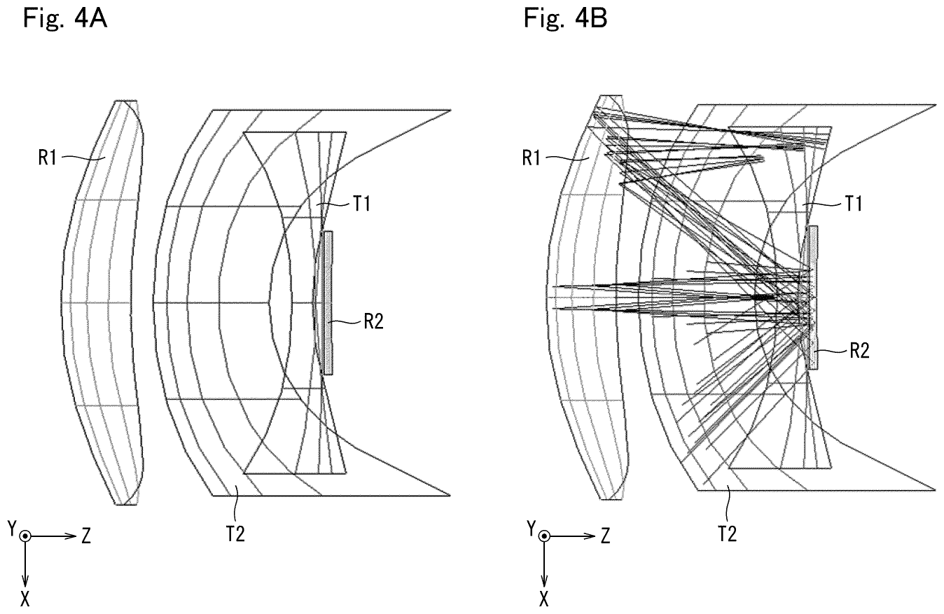

FIG. 2A is a perspective view illustrating a three-dimensional shape of each optical surface of the prism PM, and FIG. 2B illustrates a part of the light rays traveling inside the prism PM. FIG. 3A is a cross-sectional view of the prism PM along a YZ surface, and FIG. 3B illustrates a part of the light rays traveling inside the prism PM. FIG. 4A is a top view of the prism PM viewed from the Y direction, and FIG. 4B illustrates a part of the light rays traveling inside the prism PM.

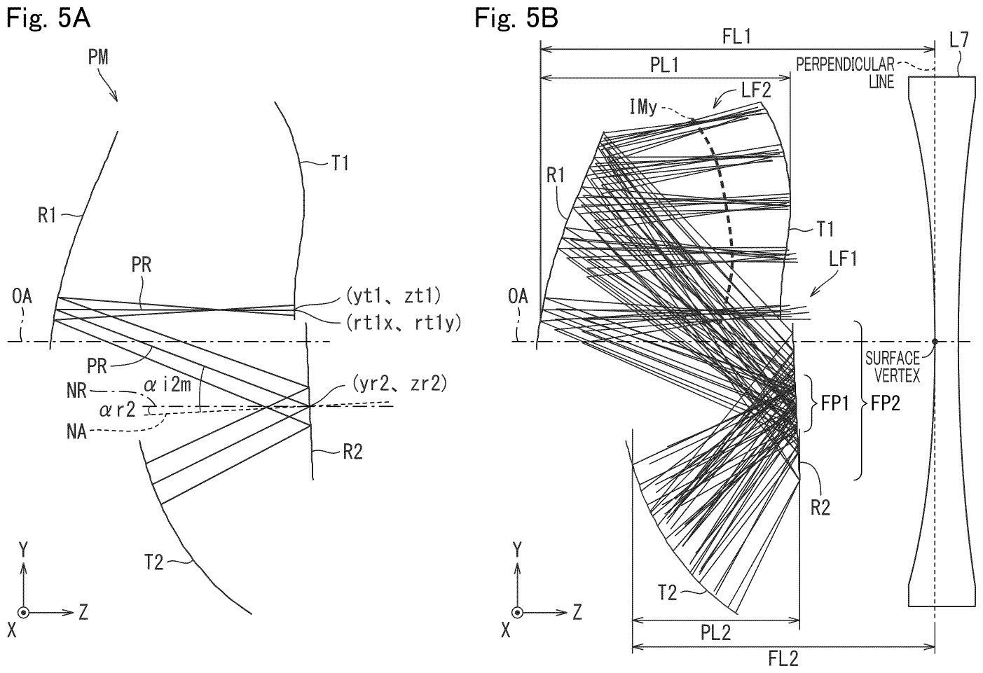

FIG. 5A is a YZ cross-sectional view for explaining definitions of a first point on the first transmission surface T1, a second point on the second reflection surface R2, and an incident angle of the light rays on the second reflection surface R2. FIG. 5B is a YZ cross-sectional view for explaining the definitions of distances PL1 and PL2. Details will be described later.

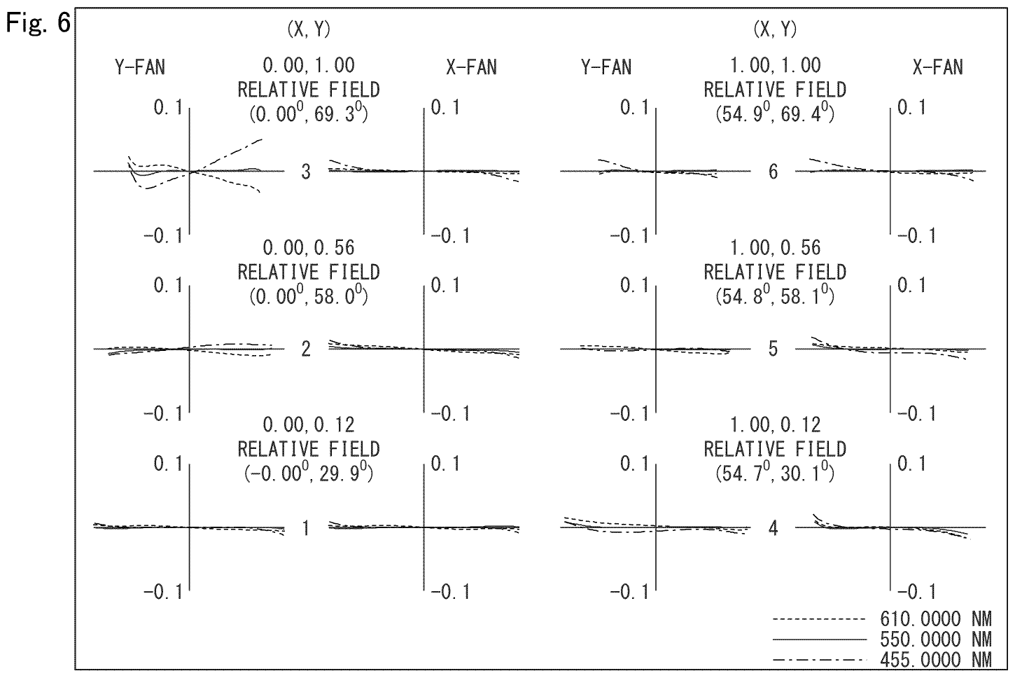

FIG. 6 is a lateral aberration diagram of the optical system 1 according to the first example. Each graph corresponds to normalized coordinates (X, Y)=(1.00, 1.00), (1.00, 0.56), (1.00, 0.12), (0.00, 1.00), (0.00, 0.56), and (0.00, 0.12) of the first rectangular effective region at the reduction conjugate point. The solid line indicates a wavelength of 550.0000 nm, the broken line indicates a wavelength of 610.0000 nm, and the alternate long and short dash line indicates a wavelength of 455.0000 nm. From these graphs, it can be seen that the optical system 1 according to the first example exhibits excellent optical performance.

### Second Example

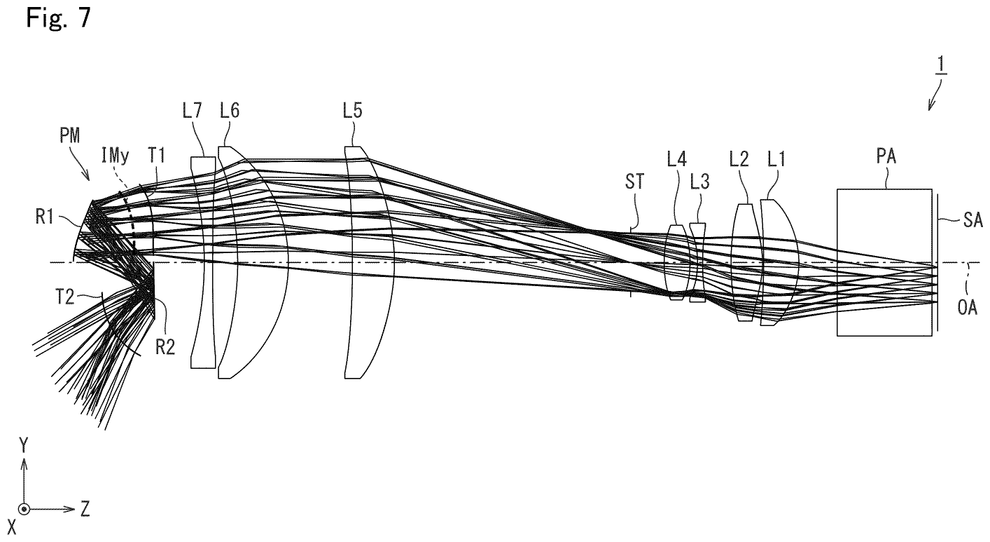

FIG. 7 is an arrangement diagram illustrating the optical system 1 according to a second example. The optical system 1 has the configuration similar to that of the first example, and the description overlapping with that of the first example will be omitted. The optical system 1 includes a first sub-optical system including an aperture stop ST and a second sub-optical system including a prism PM. In FIG. 7, the reduction conjugate point which is an image forming position on the reduction side is located on the right side of the optical axis OA, and the magnification conjugate point which is an image forming position on the magnification side is located on the lower left side of the optical axis OA. The second sub-optical system is provided closer to the magnification side than the first sub-optical system.

In addition, an intermediate imaging position that is conjugated with each of the reduction conjugate point and the magnification conjugate point is located inside the optical system 1. In this intermediate imaging position, both a Y-direction intermediate image IMy and an X-direction intermediate image IMx exist inside the prism PM. The Y-direction intermediate image IMy is illustrated in FIG. 7, but the X-direction intermediate image IMx is not illustrated.

The first sub-optical system includes an optical element PA and lens elements L1 to L7 in order from the reduction side to the magnification side. The reduction conjugate point is set at a position at a predetermined distance from the end surface of the optical element PA on the reduction side, and the original image SA is installed therein (surface 23). Regarding the surface number, a numerical example to be described later is referred to.

The optical element PA has two parallel and flat transmission surfaces (surfaces 21 and 22). The lens element L1 has a positive meniscus shape with a convex surface facing the reduction side (surfaces 19 and 20). The lens element L2 has a biconvex shape (surfaces 17 and 18). The lens element L3 has a biconcave shape (surfaces 15 and 16). The lens element L4 has a biconvex shape (surfaces 13 and 14). The lens element L5 has a positive meniscus shape with a convex surface facing the reduction side (surfaces 9 and 10). The lens element L6 has a positive meniscus shape with a convex surface facing the reduction side (surfaces 7 and 8). The lens element L7 has a biconcave shape (surfaces 5 and 6). These lens elements L1 to L7 are rotationally symmetric lenses having a surface shape rotationally symmetric around the optical axis OA, and a portion through which a light ray does not pass may be deleted as necessary.

The prism PM includes the first transmission surface T1 located on the reduction side, the second transmission surface T2 located on the magnification side, and the first reflection surface R1 and the second reflection surface R2 that are located on the optical path between the first transmission surface T1 and the second transmission surface T2. The first transmission surface T1 has a free-form surface shape with a convex surface facing the reduction side (surface 4). The first reflection surface R1 has a free-form surface shape with a concave surface facing a direction in which light rays incident on the first reflection surface R1 reflect (surface 3). The second reflection surface R2 has a free-form surface shape with a convex surface facing a direction in which light rays incident on the second reflection surface R2 reflect (surface 2). The second transmission surface T2 has a free-form surface shape with a convex surface facing the magnification side (surface 1).

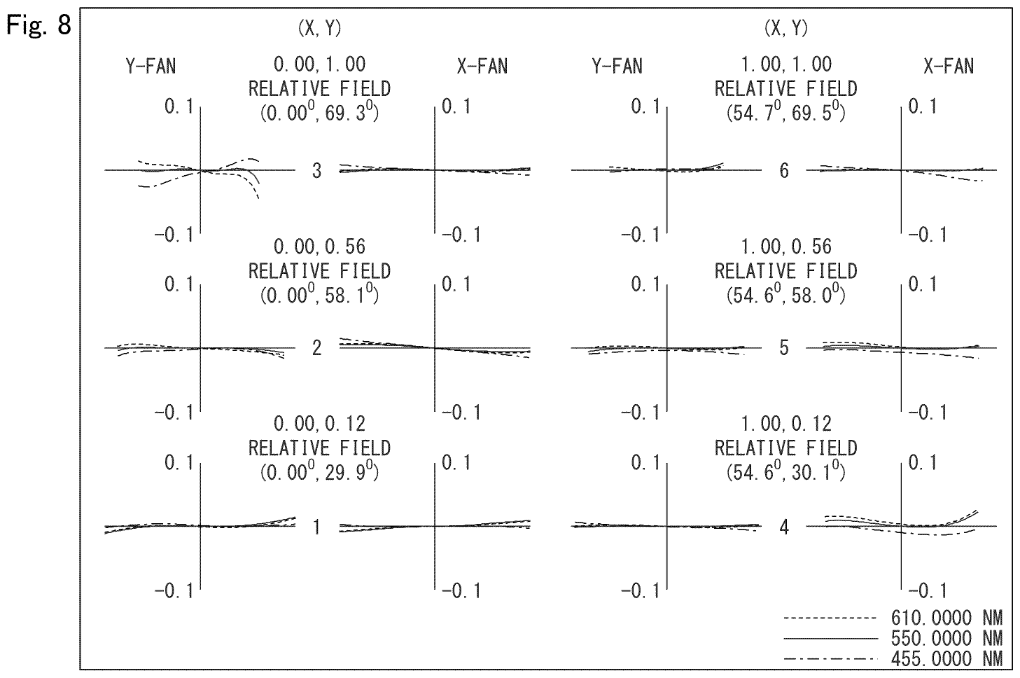

FIG. 8 is a lateral aberration diagram of the optical system 1 according to the second example. Each graph corresponds to normalized coordinates (X, Y)=(1.00, 1.00), (1.00, 0.56), (1.00, 0.12), (0.00, 1.00), (0.00, 0.56), and (0.00, 0.12) of the first rectangular effective region at the reduction conjugate point. From these graphs, it can be seen that the optical system 1 according to the second example exhibits excellent optical performance.

### Third Example

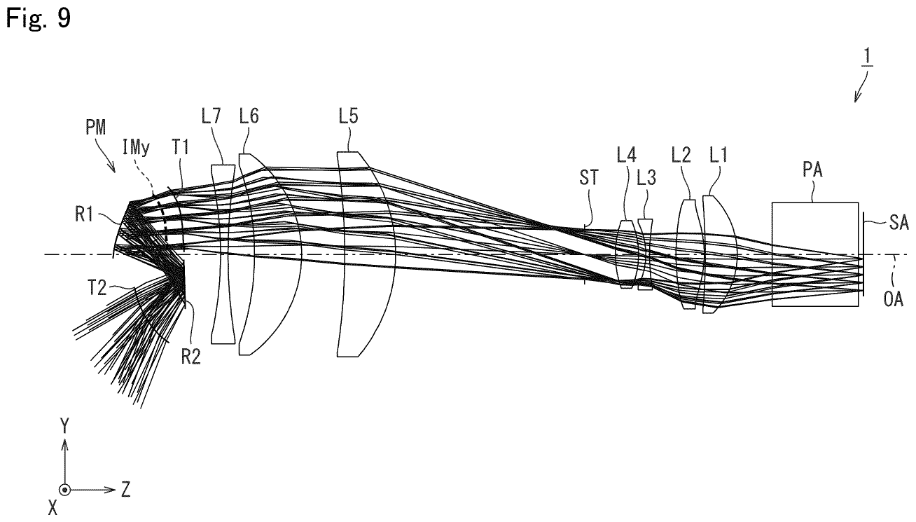

FIG. 9 is an arrangement diagram illustrating the optical system 1 according to a third example. The optical system 1 has the configuration similar to that of the first example, and the description overlapping with that of the first example will be omitted. The optical system 1 includes a first sub-optical system including an aperture stop ST and a second sub-optical system including a prism PM. In FIG. 9, the reduction conjugate point which is an image forming position on the reduction side is located on the right side of the optical axis OA, and the magnification conjugate point which is an image forming position on the magnification side is located on the lower left side of the optical axis OA. The second sub-optical system is provided closer to the magnification side than the first sub-optical system.

In addition, an intermediate imaging position that is conjugated with each of the reduction conjugate point and the magnification conjugate point is located inside the optical system 1. In this intermediate imaging position, both a Y-direction intermediate image IMy and an X-direction intermediate image IMx exist inside the prism PM. The Y-direction intermediate image IMy is illustrated in FIG. 9, but the X-direction intermediate image IMx is not illustrated.

The first sub-optical system includes an optical element PA and lens elements L1 to L7 in order from the reduction side to the magnification side. The reduction conjugate point is set at a position at a predetermined distance from the end surface of the optical element PA on the reduction side, and the original image SA is installed therein (surface 23). Regarding the surface number, a numerical example to be described later is referred to.

The optical element PA has two parallel and flat transmission surfaces (surfaces 21 and 22). The lens element L1 has a positive meniscus shape with a convex surface facing the reduction side (surfaces 19 and 20). The lens element L2 has a biconvex shape (surfaces 17 and 18). The lens element L3 has a biconcave shape (surfaces 15 and 16). The lens element L4 has a biconvex shape (surfaces 13 and 14). The lens element L5 has a positive meniscus shape with a convex surface facing the reduction side (surfaces 9 and 10). The lens element L6 has a positive meniscus shape with a convex surface facing the reduction side (surfaces 7 and 8). The lens element L7 has a biconcave shape (surfaces 5 and 6). These lens elements L1 to L7 are rotationally symmetric lenses having a surface shape rotationally symmetric around the optical axis OA, and a portion through which a light ray does not pass may be deleted as necessary.

The prism PM includes the first transmission surface T1 located on the reduction side, the second transmission surface T2 located on the magnification side, and the first reflection surface R1 and the second reflection surface R2 that are located on the optical path between the first transmission surface T1 and the second transmission surface T2. The first transmission surface T1 has a free-form surface shape with a convex surface facing the reduction side (surface 4). The first reflection surface R1 has a free-form surface shape with a concave surface facing a direction in which light rays incident on the first reflection surface R1 reflect (surface 3). The second reflection surface R2 has a free-form surface shape with a convex surface facing a direction in which light rays incident on the second reflection surface R2 reflect (surface 2). The second transmission surface T2 has a free-form surface shape with a convex surface facing the magnification side (surface 1).

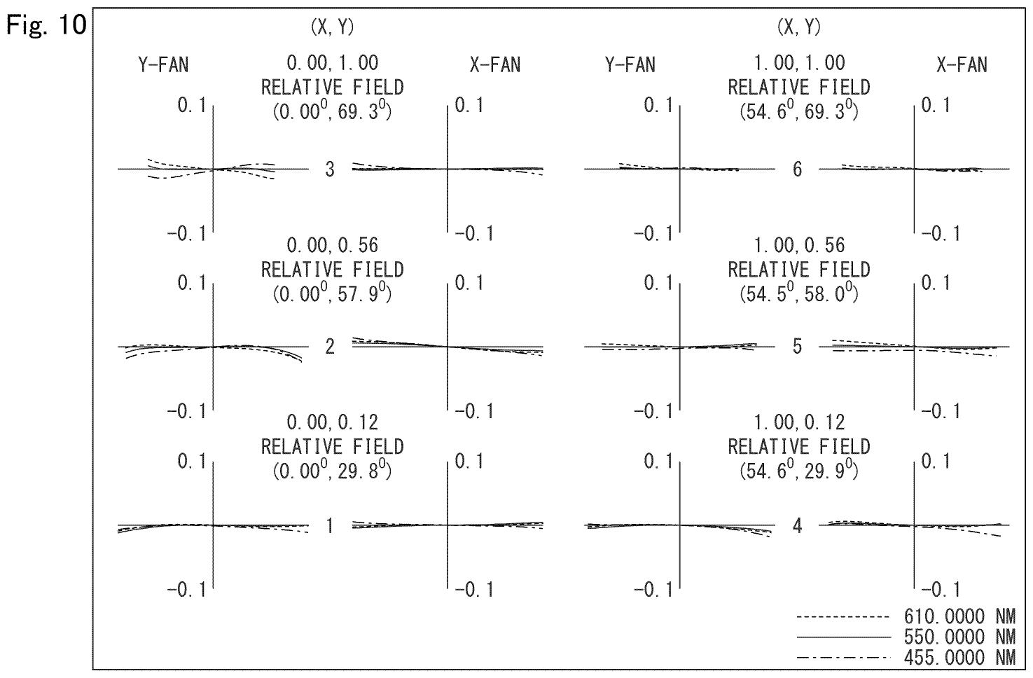

FIG. 10 is a lateral aberration diagram of the optical system 1 according to the third example. Each graph corresponds to normalized coordinates (X, Y)=(1.00, 1.00), (1.00, 0.56), (1.00, 0.12), (0.00, 1.00), (0.00, 0.56), and (0.00, 0.12) of the first rectangular effective region at the reduction conjugate point. From these graphs, it can be seen that the optical system 1 according to the third example exhibits excellent optical performance.

### Fourth Example

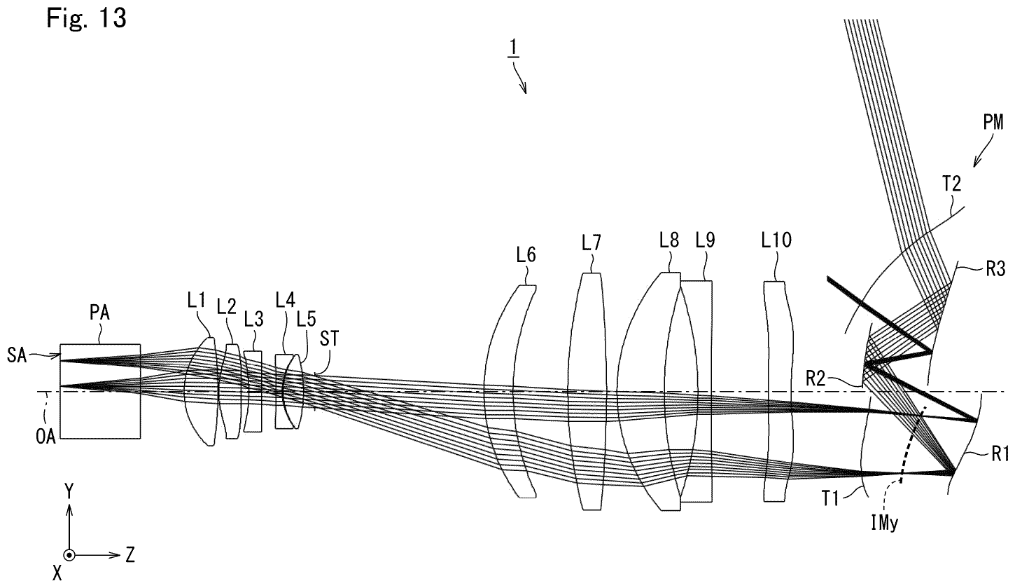

FIG. 13 is an arrangement diagram illustrating the optical system 1 according to a fourth example. The optical system 1 includes a first sub-optical system including an aperture stop ST and a second sub-optical system including a prism PM. In FIG. 13, the reduction conjugate point which is the image forming position on the reduction side is located on the left side of the optical axis OA, and the magnification conjugate point which is the image forming position on the magnification side is located obliquely upward from the prism PM. The second sub-optical system is provided closer to the magnification side than the first sub-optical system.

In addition, an intermediate imaging position that is conjugated with each of the reduction conjugate point and the magnification conjugate point is located inside the optical system 1. In this intermediate imaging position, both a Y-direction intermediate image IMy and an X-direction intermediate image IMx exist inside the prism PM. The Y-direction intermediate image IMy is illustrated in FIG. 13, but the X-direction intermediate image IMx is not illustrated.

The first sub-optical system includes the optical element PA and the lens elements L1 to L10 in order from the reduction side to the magnification side. The optical element PA represents an optical element such as a total internal reflection (TIR) prism, a prism for color separation and color synthesis, an optical filter, a parallel and flat plate glass, a crystal low-pass filter, and an infrared cut filter. The reduction conjugate point is set at a position at a predetermined distance from the end surface of the optical element PA1 on the reduction side, and the original image SA is installed therein (surface 0). Regarding the surface number, a numerical example to be described later is referred to.

The optical element PA has two parallel and flat transmission surfaces (surfaces 1 and 2). The lens element L1 has a biconvex shape (surfaces 3 and 4). The lens element L2 has a biconvex shape (surfaces 5 and 6). The lens element L3 has a biconcave shape (surfaces 7 and 8). The lens element L4 has a biconcave shape (surfaces 9 and 10). The lens element L5 has a biconvex shape (surfaces 11 and 12). The lens element L6 has a positive meniscus shape with a convex surface facing the reduction side (surfaces 15 and 16). The lens element L7 has a biconvex shape (surfaces 17 and 18). The lens element L8 has a positive meniscus shape with a convex surface facing the reduction side (surfaces 19 and 20). The lens element L9 has a biconcave shape (surfaces 21 and 22). The lens element L10 has a negative meniscus shape with a convex surface facing the reduction side (surfaces 23 and 24). These lens elements L1 to L10 are rotationally symmetric lenses having a surface shape rotationally symmetric around the optical axis OA of the first sub-optical system, and a portion through which a light ray does not pass may be deleted as necessary.

The second sub-optical system includes the prism PM formed of a transparent medium, for example, glass, synthetic resin, or the like. The prism PM includes, as a plurality of optical surfaces, the first transmission surface T1 located on the reduction side, the second transmission surface T2 located on the magnification side, and the first reflection surface R1, the second reflection surface R2, and the third reflection surface R3 that are located on the optical path between the first transmission surface T1 and the second transmission surface T2. The first transmission surface T1 has a free-form surface shape with a convex surface facing the reduction side (surface 25). The first reflection surface R1 has a free-form surface shape with a convex surface and a concave surface facing a direction in which light rays incident on the first reflection surface R1 reflect (surface 26). The second reflection surface R2 has a free-form surface shape with a concave surface facing a direction in which light rays incident on the second reflection surface R2 reflect (surface 27). The third reflection surface R3 has a free-form surface shape with a convex surface facing a direction in which light rays incident on the third reflection surface R3 reflect (surface 28). The second transmission surface T2 has a free-form surface shape with a convex surface facing the magnification side (surface 29).

The aperture stop ST defines a range in which a light flux passes through the optical system 1, and is positioned between the reduction conjugate point and the above-described intermediate imaging position. As an example, the aperture stop ST is located between the lens element L5 and the lens element L6 (surface 13).

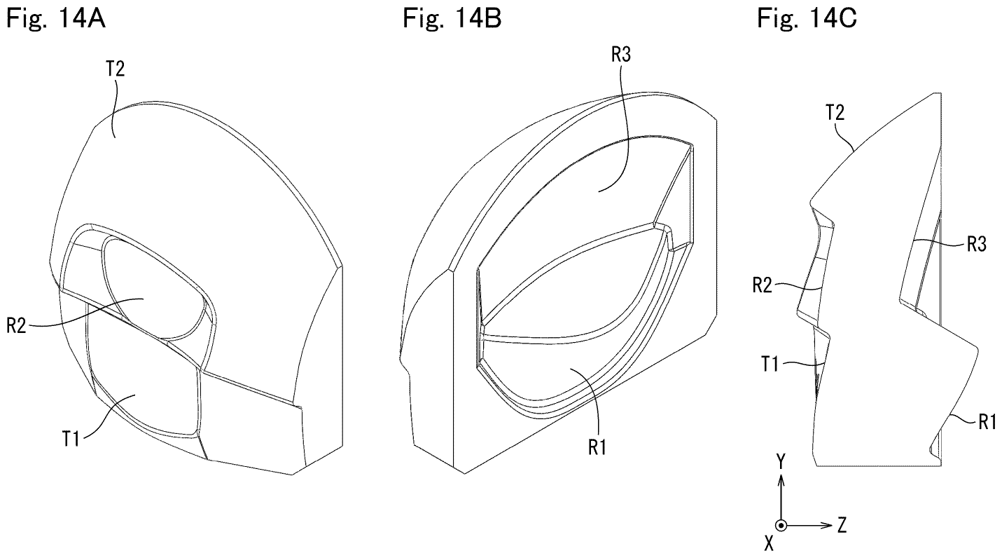

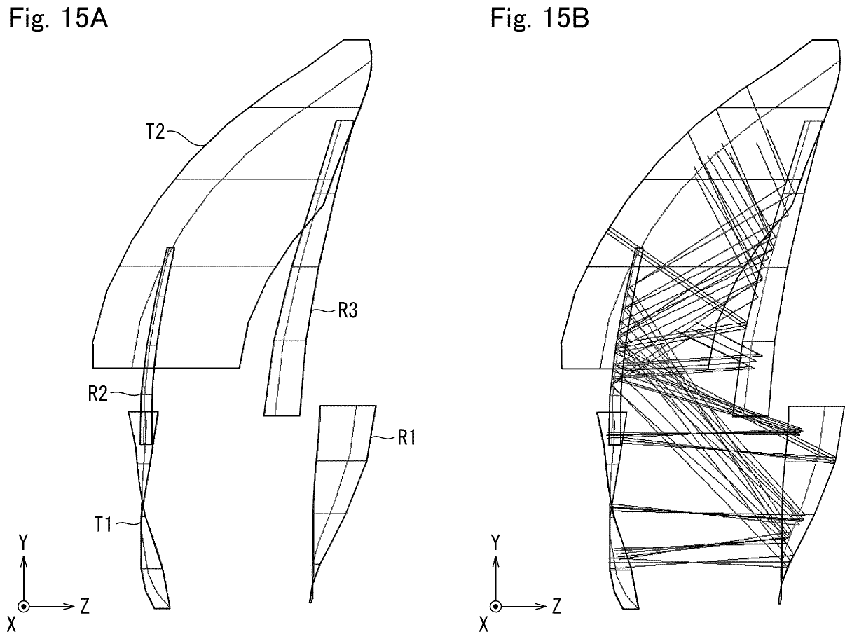

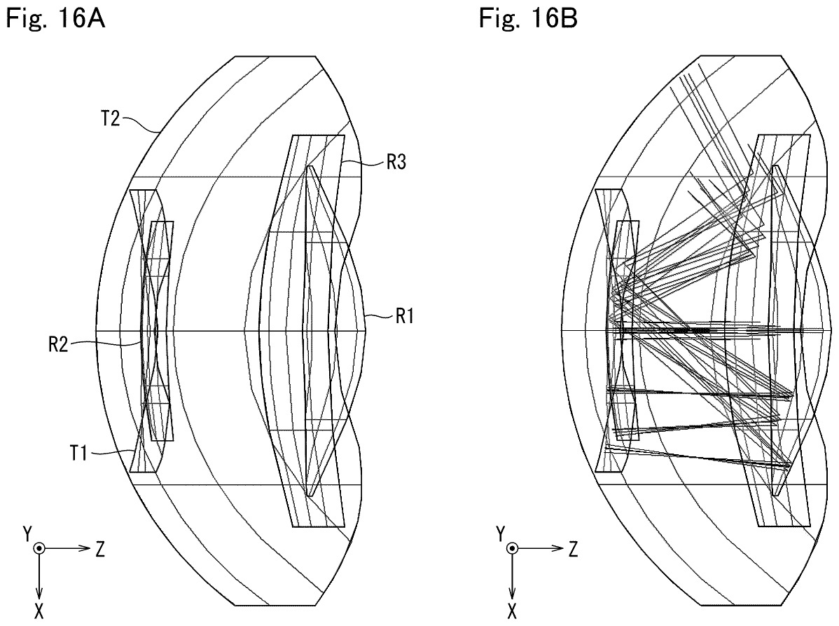

FIG. 14A is a front perspective view illustrating a three-dimensional shape of each optical surface of the prism PM. FIG. 14B is a rear perspective view illustrating a three-dimensional shape of each optical surface of the prism PM. FIG. 14C is a side view illustrating a three-dimensional shape of the prism PM. FIG. 15A is a side view illustrating relative positions of the first transmission surface T1, the second transmission surface T2, the first reflection surface R1, the second reflection surface R2, and the third reflection surface R3. FIG. 15B is a side view illustrating a part of the light rays traveling inside the prism PM. FIG. 16A is a top view illustrating relative positions of the first transmission surface T1, the second transmission surface T2, the first reflection surface R1, the second reflection surface R2, and the third reflection surface R3 viewed from the Y direction. FIG. 16B is a top view illustrating a part of the light rays traveling inside the prism PM.

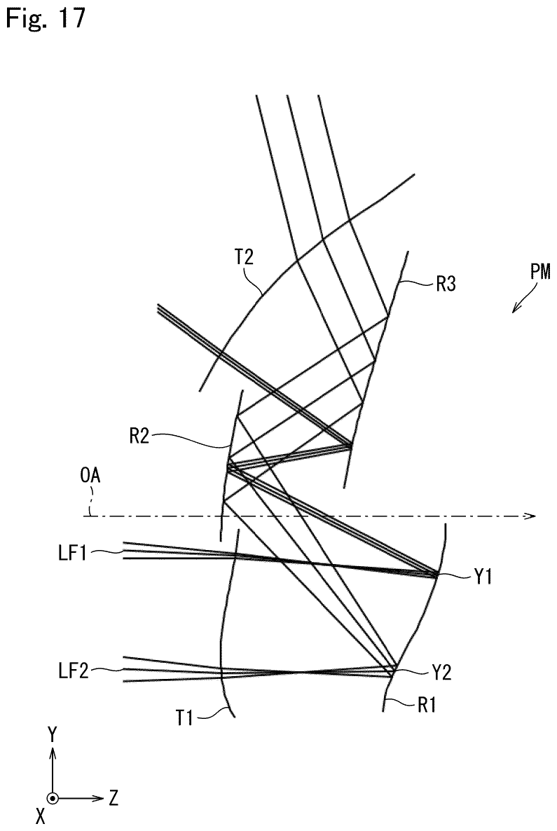

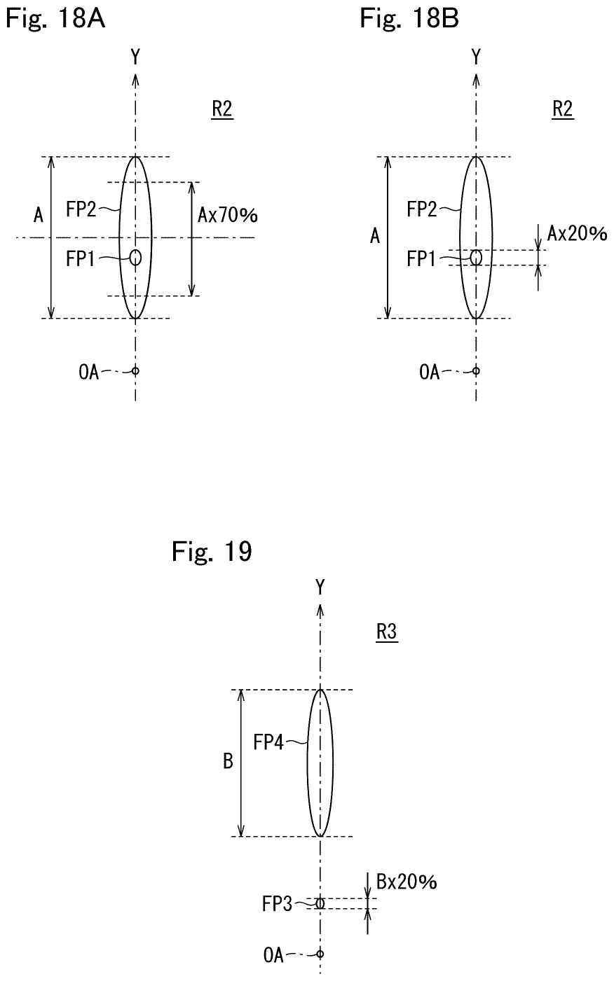

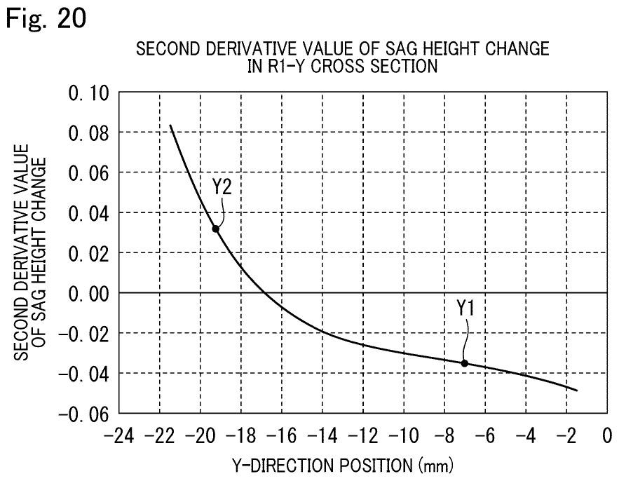

FIG. 17 is a YZ cross-sectional view illustrating a state in which a first light flux LF1 and a second light flux LF2 travel in order of the first transmission surface T1, the second transmission surface T2, the first reflection surface R1, the second reflection surface R2, and the third reflection surface R3. FIGS. 18A and 18B are explanatory views illustrating a relationship between a first footprint region FP1 of the first light flux LF1 and a second footprint region FP2 of the second light flux LF2 on the second reflection surface R2. FIG. 19 is an explanatory view illustrating a relationship between a third footprint region FP3 of the first light flux LF1 and a fourth footprint region FP4 of the second light flux LF2 on the third reflection surface R3. FIG. 20 is a graph illustrating a second derivative value of a sag height change on a Y cross section on the first reflection surface R1. Details thereof will be described later.

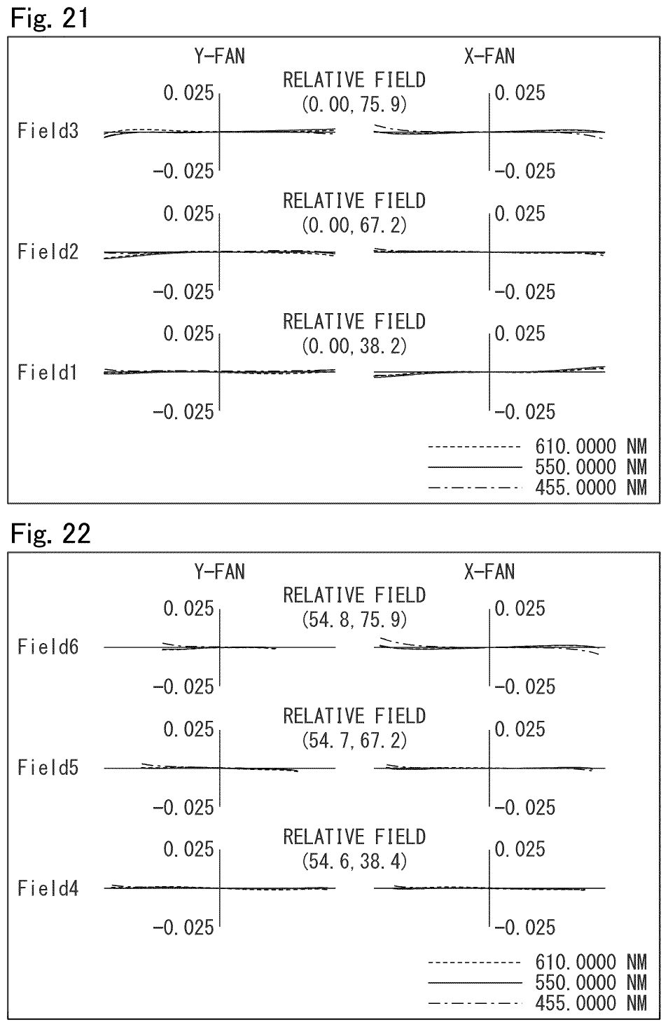

FIGS. 21 to 23 are lateral aberration diagrams of the optical system 1 according to the fourth example. Each graph corresponds to coordinates (X, Y)=(0.00, 75.9), (0.00, 67.2), (0.00, 38.2), (54.6, 75.9), (54.7, 67.2), (54.6, 38.4), (70.6, 75.9), (70.6, 67.3), and (70.6, 38.6) of the first rectangular region at the reduction conjugate point. The solid line indicates a wavelength of 550.0000 nm, the broken line indicates a wavelength of 610.0000 nm, and the alternate long and short dash line indicates a wavelength of 455.0000 nm. From these graphs, it can be seen that the optical system 1 according to the fourth example exhibits excellent optical performance.

### Fifth Example

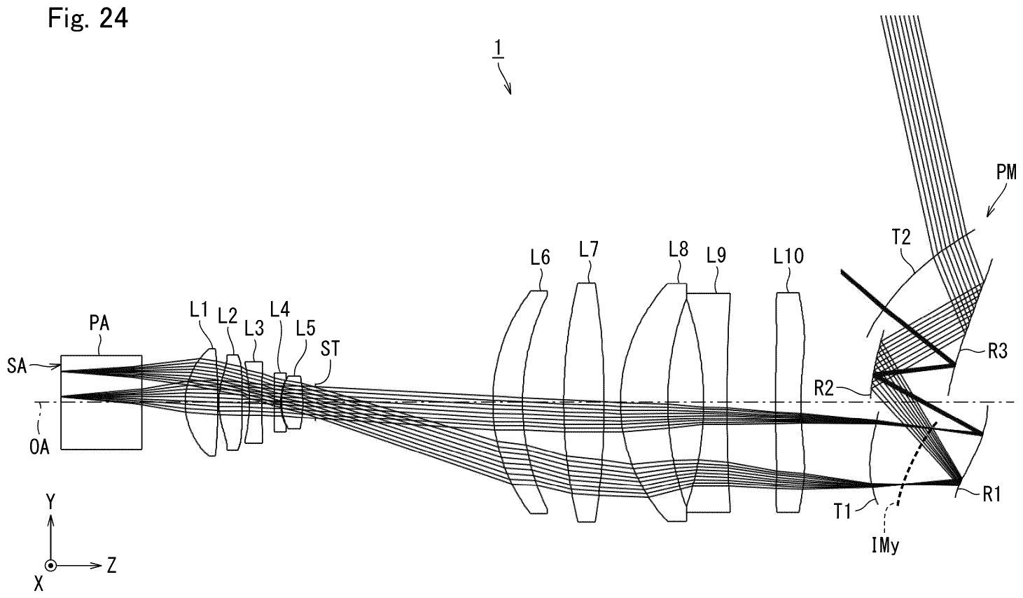

FIG. 24 is an arrangement diagram illustrating the optical system 1 according to a fifth example. The optical system 1 has the configuration similar to that of the fourth example, and the description overlapping with that of the fourth example will be omitted. The optical system 1 includes a first sub-optical system including an aperture stop ST and a second sub-optical system including a prism PM. In FIG. 24, the reduction conjugate point which is the image forming position on the reduction side is located on the left side of the optical axis OA, and the magnification conjugate point which is the image forming position on the magnification side is located obliquely upward from the prism PM. The second sub-optical system is provided closer to the magnification side than the first sub-optical system.

In addition, an intermediate imaging position that is conjugated with each of the reduction conjugate point and the magnification conjugate point is located inside the optical system 1. In this intermediate imaging position, both a Y-direction intermediate image IMy and an X-direction intermediate image IMx exist inside the prism PM. The Y-direction intermediate image IMy is illustrated in FIG. 24, but the X-direction intermediate image IMx is not illustrated.

The first sub-optical system includes the optical element PA and the lens elements L1 to L10 in order from the reduction side to the magnification side. The reduction conjugate point is set at a position at a predetermined distance from the end surface of the optical element PA on the reduction side, and the original image SA is installed therein (surface 0). Regarding the surface number, a numerical example to be described later is referred to.

Each of the optical elements PA has two parallel and flat transmission surfaces (surfaces 1 and 2). The lens element L1 has a biconvex shape (surfaces 3 and 4). The lens element L2 has a biconvex shape (surfaces 5 and 6). The lens element L3 has a biconcave shape (surfaces 7 and 8). The lens element L4 has a biconcave shape (surfaces 9 and 10). The lens element L5 has a biconvex shape (surfaces 11 and 12). The lens element L6 has a positive meniscus shape with a convex surface facing the reduction side (surfaces 15 and 16). The lens element L7 has a biconvex shape (surfaces 17 and 18). The lens element L8 has a positive meniscus shape with a convex surface facing the reduction side (surfaces 19 and 20). The lens element L9 has a biconcave shape (surfaces 21 and 22). The lens element L10 has a negative meniscus shape with a convex surface facing the reduction side (surfaces 23 and 24). These lens elements L1 to L10 are rotationally symmetric lenses having a surface shape rotationally symmetric around the optical axis OA of the first sub-optical system, and a portion through which a light ray does not pass may be deleted as necessary.

The prism PM includes, as a plurality of optical surfaces, the first transmission surface T1 located on the reduction side, the second transmission surface T2 located on the magnification side, and the first reflection surface R1, the second reflection surface R2, and the third reflection surface R3 that are located on the optical path between the first transmission surface T1 and the second transmission surface T2. The first transmission surface T1 has a free-form surface shape with a convex surface facing the reduction side (surface 25). The first reflection surface R1 has a free-form surface shape with a convex surface and a concave surface facing a direction in which light rays incident on the first reflection surface R1 reflect (surface 26). The second reflection surface R2 has a free-form surface shape with a concave surface facing a direction in which light rays incident on the second reflection surface R2 reflect (surface 27). The third reflection surface R3 has a free-form surface shape with a convex surface facing a direction in which light rays incident on the third reflection surface R3 reflect (surface 28). The second transmission surface T2 has a free-form surface shape with a convex surface facing the magnification side (surface 29).

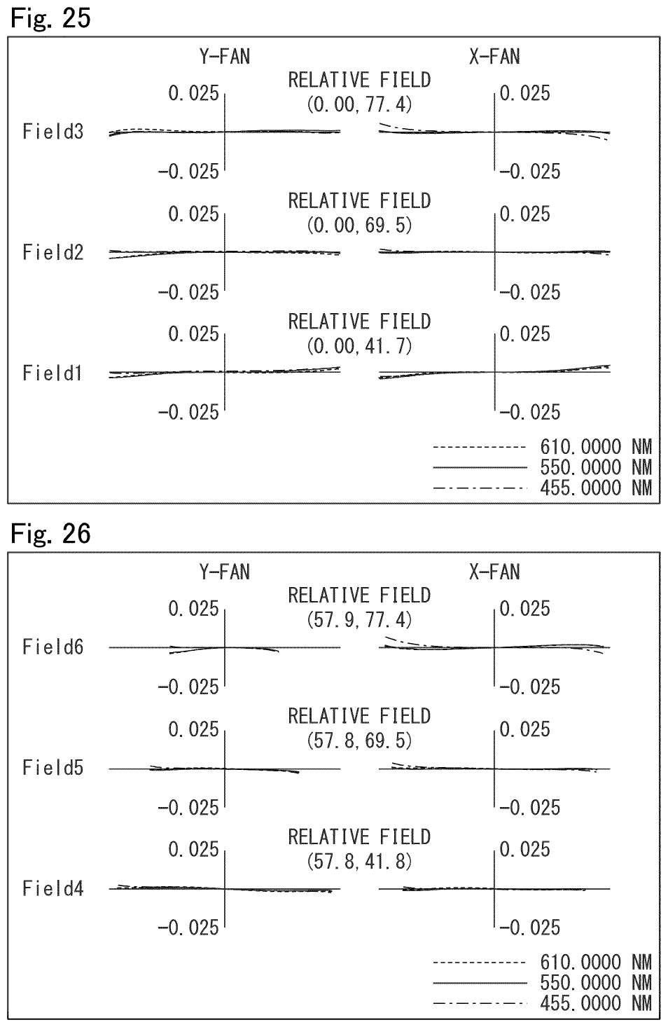

FIGS. 25 to 27 are lateral aberration diagrams of the optical system 1 according to the fifth example. Each graph corresponds to coordinates (X, Y)=(0.00, 75.9), (0.00, 67.2), (0.00, 38.2), (54.6, 75.9), (54.7, 67.2), (54.6, 38.4), (70.6, 75.9), (70.6, 67.3), and (70.6, 38.6) of the first rectangular region at the reduction conjugate point. From these graphs, it can be seen that the optical system 1 according to the fifth example exhibits excellent optical performance.

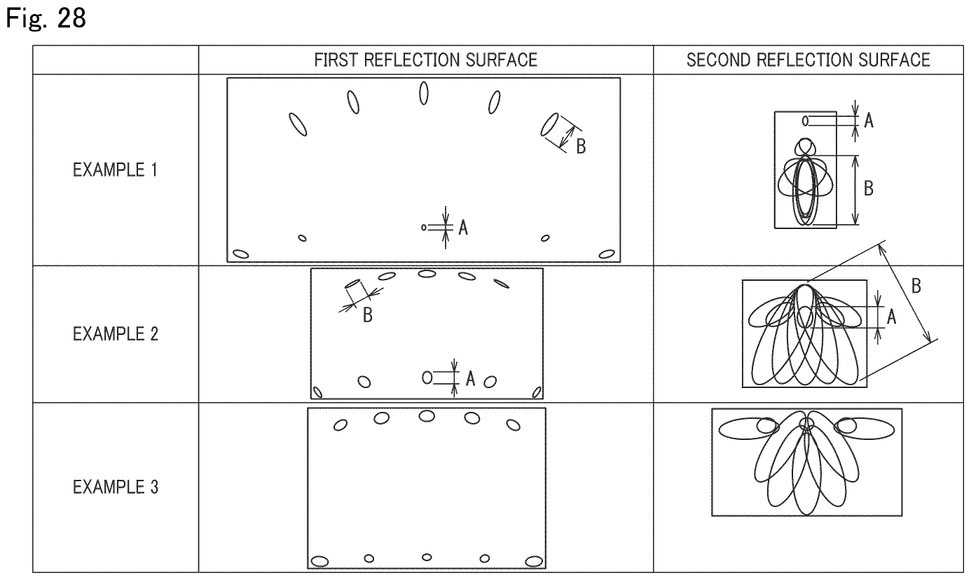

FIG. 28 corresponds to FIG. 9 attached to the basic application (JP 2023-198654 A) of priority of the present application, and is an explanatory view illustrating shapes of footprints on the first reflection surface R1 and the second reflection surface R2 according to the first to third examples of the basic application. With respect to the first to third examples of the basic application, a first principal ray passes through a position close to the lower end of the first reflection surface R1, and subsequently passes through a position close to the upper end of the second reflection surface R2. A second principal ray passes through a position close to the upper end of the first reflection surface R1, and subsequently passes through a position close to the center of the second reflection surface R2. The footprint of the first principal ray tends to be larger than the footprint of the second principal ray, and this tendency is particularly large in the second reflection surface R2. In particular, focusing on the second reflection surface R2 of the second example, it can be seen that a footprint A located at the center of the first principal ray overlaps a footprint B located at the center of the second principal ray.

Next, conditions that can be satisfied by the optical system according to the present embodiment will be described. Note that, although a plurality of conditions is defined for the optical system according to each embodiment, all of the plurality of conditions may be satisfied, or by satisfying individual conditions, corresponding effects can be obtained.

The optical system according to the present embodiment is an optical system having a reduction conjugate point on a reduction side and a magnification conjugate point on a magnification side, and having an intermediate imaging position that is conjugate with each of the reduction conjugate point and the magnification conjugate point inside, the optical system includes:
a first sub-optical system including a plurality of lenses arranged along an optical axis OA in a Z direction, and an aperture stop between two lenses among the plurality of lenses; and
a second sub-optical system disposed closer to the magnification side than the first sub-optical system and including a prism PM having a plurality of optical surfaces, in which
the prism PM includes: as the plurality of optical surfaces,
   a first transmission surface T1 located on the reduction side;
   a second transmission surface T2 located on the magnification side; and
   a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface,
a light flux travels in a YZ surface including the Z direction and a Y direction perpendicular to the Z direction inside the prism,
the second transmission surface has a shape with a convex surface facing the magnification side, and a reflection surface located on a most magnification side in the reflection surface group has a convex shape with respect to the inside of the prism, the intermediate imaging position of a first light flux LF1 closest to the optical axis OA is disposed between the first transmission surface T1 and the first reflection surface R1,
the first reflection surface R1 has stronger positive power than the second reflection surface R2, and
on the YZ surface with respect to an effective region of the plurality of optical surfaces,
a distance FL2 is smaller than a distance FL1 in the distance FL1 between a point of the first reflection surface R1 farthest from a perpendicular line of the optical axis OA passing through a surface vertex of an optical surface on a most magnification side of the first sub-optical system and the perpendicular line and the distance FL2 between a point of the second transmission surface T2 farthest from the perpendicular line and the perpendicular line.

As illustrated in FIG. 5A, the prism PM has, as the optical surfaces, the first transmission surface T1, the first reflection surface R1, the second reflection surface R2, and the second transmission surface T2 in order from the reduction side to the magnification side. Here, the distance FL1 between a point of the first reflection surface R1, which is farthest from a perpendicular line of the optical axis OA passing through a surface vertex of the optical surface on the most magnification side of the first sub-optical system, and the perpendicular line, and the distance FL2 between a point of the second transmission surface T2, which is farthest from the perpendicular line, and the perpendicular line can be defined. As illustrated, the first transmission surface T1 and the first reflection surface R1 need a predetermined distance so that the first reflection surface R1 reflects the plurality of light fluxes incident from the first sub-optical system to the second reflection surface R2. In this case, by designing the distance FL2 to be smaller than the distance FL1, the optical system can be shortened in the Z direction, and as a result, the prism PM can be downsized.

In the optical system according to the present embodiment, on the YZ surface, in a distance PL1 parallel to the Z direction between a point of the first transmission surface T1 closest to the perpendicular line and a point of the first reflection surface R1 farthest from the perpendicular line, and in a distance PL2 parallel to the Z direction between a point of the second reflection surface R2 closest to the perpendicular line and a point of the second transmission surface T2 farthest from the perpendicular line, the distance PL2 may be smaller than the distance PL1.

As illustrated in FIG. 5B, since the distance PL2 is smaller than the distance PL1, the prism can be reduced in size in the Z direction. Furthermore, in a case where shift projection is performed in the Y direction, the second transmission surface T2 tends to increase in size in the Y direction. Therefore, by reducing the size of the second transmission surface T2 in the Z direction, it is also possible to suppress an increase in size in the Y direction.

In the optical system according to the present embodiment, in a case where a YZ coordinate (yt1, zt1) of a first point through which a principal ray PR of the first light flux LF1 passes on the first transmission surface is compared with a YZ coordinate (yr2, zr2) of a second point from which the principal ray PR of the first light flux LF1 reflects on the second reflection surface R2, a Z coordinate interval |zr2−zt1| may be smaller than a Y coordinate interval |yr2−yt1|. Here, |x| represents an absolute value of x.

For easy understanding, FIG. 5A illustrates only the light flux closest to the optical axis OA and the principal ray PR thereof among all the light rays passing through or reflecting the effective region of the optical surface. In this case, the YZ coordinate (yt1, zt1) of the first point through which the principal ray PR passes on the first transmission surface T1 can be defined. In addition, the YZ coordinate (yr2, zr2) of the second point at which the principal ray PR reflects on the second reflection surface R2 can be defined.

In a case where both YZ coordinates are compared with each other, the arrangement of the first transmission surface T1 and the second reflection surface R2 is designed such that |zr2−zt1| is smaller than the Y-coordinate interval |yr2−yt1|. Note that, in FIG. 5A, the Z coordinate zt1 of the first point is located on the +Z side (the right side of FIG. 5A) with respect to the Z coordinate zr2 of the second point. However, the Z coordinate zt1 of the first point may be located on the −Z side (the left side of FIG. 5A) with respect to the Z coordinate zr2 of the second point. Furthermore, the Z coordinate zt1 of the first point and the Z coordinate zr2 of the second point may be the same, and in this case, the interval |zr2−zt1| (=0) of the Z coordinate may be smaller than the interval |yr2−yt1| of the Y coordinate.

Next, as illustrated in FIG. 5B, the distance PL1 parallel to the optical axis OA of the first sub-optical system between a point of the first transmission surface T1 closest to the perpendicular line of the optical axis OA passing through a surface vertex (intersection of the optical surface and the optical axis) of the optical surface (magnification side surface of the lens element L7) closest to the magnification side of the first sub-optical system and a point of the first reflection surface R1 farthest from the perpendicular line can be defined. In addition, the distance PL2 parallel to the optical axis OA of the first sub-optical system between the point of the second reflection surface R2 closest to the perpendicular line and the point of the second transmission surface T2 farthest from the perpendicular line can be defined. In this case, the arrangement of the first transmission surface T1, the first reflection surface R1, the second reflection surface R2, and the second transmission surface T2 is designed such that the distance PL2 is smaller than the distance PL1.

According to such a configuration, since the first transmission surface T1 and the second reflection surface R2 can be maintained substantially perpendicular to the optical axis OA, the prism PM can be easily manufactured. Conversely, when the first transmission surface T1 and the second reflection surface R2 are too inclined with respect to the optical axis OA, it becomes difficult to manufacture the prism PM. In addition, since the first transmission surface T1 and the second reflection surface R2 are close to each other in the Z direction, and the distance PL2 is smaller than the distance PL1, the prism having the free-form surface can be downsized.

The optical system according to the present embodiment may satisfy the following formulae (1) and (2).

$$0.5 < PL 2 / PL 1 < 0.8 \qquad ( 1 )$$

$$\vert ( zr 2 - zt 1 ) / ( yr 2 - yt 1 ) \vert < 1. \qquad ( 2 )$$

According to such a configuration, the manufacturing of the prism PM is further facilitated by satisfying formulae (1) and (2). In addition, the prism having the free-form surface can be further downsized.

The optical system according to the present embodiment may satisfy the following formula (3).

$$0.5 < α r 2 < 3. \qquad ( 3 )$$

Here,
αr2 is an angle (unit: °) formed between a normal line at a position of the second reflection surface R2 on which the principal ray PR of the first light flux LF1 is made incident and a normal line of the conjugate surface including the reduction conjugate point.

As illustrated in FIG. 5A, the principal ray PR of the light flux closest to the optical axis OA reflects off the first reflection surface R1, and then is made incident on the second point (yr2, zr2) on the second reflection surface R2. In this case, a normal line NA at the second point (yr2, zr2) can be defined. On the other hand, a normal line NR of the conjugate surface including the reduction conjugate point can be defined. In general, the normal line NR can be set parallel to the optical axis OA of the optical system. Therefore, the angle αr2 formed by the normal line NA and the normal line NR satisfies formula (3), so that it is possible to downsize the prism while achieving oblique projection or imaging of the large screen image perpendicular to the optical axis OA to the magnification conjugate point.

The optical system according to the present embodiment may satisfy the following formula (4).

$$0. < rt 1 x / rt 1 y < 0.8 \qquad ( 4 )$$

Here,
rt1x is a partial curvature radius in the x direction of the first transmission surface T1 at the first point through which a principal ray of the first light flux LF1 passes, and
rt1y is a partial curvature radius in the y direction of the first transmission surface T1 at the first point through which the principal ray of the first light flux LF1 passes.

As illustrated in FIG. 5A, the YZ coordinate (yt1, zt1) of the first point through which the principal ray PR passes has the partial curvature radius rt1x in the x direction and the partial curvature radius rt1y in the y direction. In this case, both the partial curvature radius rt1x and the partial curvature radius rt1y satisfy formula (4), so that it is possible to suppress astigmatism at the magnification conjugate point while achieving oblique projection or imaging to the magnification conjugate point.

The optical system according to the present embodiment may satisfy the following formula (5).

$$15 < α i 2 m < 30 \qquad ( 5 )$$

Here,
αi2m is an incident angle (unit: °) at which the principal ray PR of the first light flux LF1 is made incident on the second reflection surface R2.

As illustrated in FIG. 5A, the principal ray PR of the light flux closest to the optical axis OA reflects off the first reflection surface R1, and then is made incident on the second point (yr2, zr2) on the second reflection surface R2. In this case, the incident angle at which the principal ray PR is made incident on the second reflection surface R2 can be defined by the incident angle αi2m formed between the normal line NA at the second point and the traveling direction of the principal ray PR. Therefore, the incident angle αi2m satisfies formula (5), so that it is possible to suppress the field curvature at the magnification conjugate point while achieving oblique projection or imaging of the large screen image perpendicular to the optical axis OA to the magnification conjugate point.

In the optical system according to the present embodiment, in the Z direction, the optical system may be disposed between a reduction conjugate surface formed at the position of the reduction conjugate point and a magnification conjugate surface formed at the position of the magnification conjugate point, and the reduction conjugate surface and the magnification conjugate surface may be parallel to each other.

According to such a configuration, a light ray that projects a large screen image perpendicular to the optical axis OA in an oblique direction toward a screen does not pass around the optical system. Therefore, an arbitrary member can be installed around the optical system, and for example, the optical system can be concealed from the visual field of the audience.

The optical system according to the present embodiment may satisfy the following formula (6).

$$\vert ( SF / V ) \times ( H / D ) \vert > 2.7 \qquad ( 6 )$$

Here,
D is a distance between the magnification conjugate point and the optical system,
V is a length in a first direction parallel to a vertical direction to the magnification conjugate point perpendicular to the optical axis, of an effective region in which all light rays are projected or imaged on a conjugate surface including the magnification conjugate point,
H is a length in a second direction perpendicular to the vertical direction, of an effective region in which all light rays are projected or imaged on the conjugate surface including the magnification conjugate point, and
SF is a vertical distance from the optical axis to a center of a length of the effective region in the first direction.

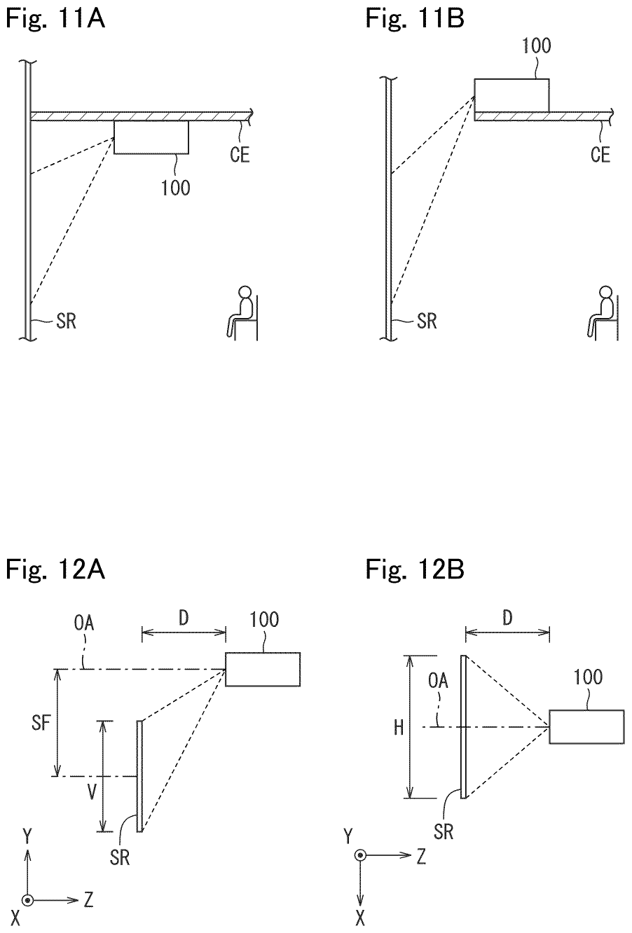

For example, as illustrated in FIG. 11A, in a case where the optical system is mounted on the image projection apparatus 100 and oblique projection is performed toward a screen SR (magnification conjugate point), the image projection apparatus 100 is generally installed on the lower surface of the ceiling CE in many cases. The audience views an image projected on the screen SR, but also recognizes the presence of the image projection apparatus 100. On the other hand, as illustrated in FIG. 11B, it can be assumed that the image projection apparatus 100 is installed on the upper surface of ceiling CE to perform oblique projection toward the screen SR. In this case, since the image projection apparatus 100 is concealed by the ceiling CE, it is difficult for the audience to recognize the presence of the image projection apparatus 100, and the audience can immerse themselves in the image viewing. In order to realize the arrangement of FIG. 11B, an optical system capable of performing projection in an oblique direction greatly inclined with respect to the screen SR of a large screen image perpendicular to the optical axis OA is required.

Note that, in FIGS. 11A and 11B, an example has been described in which the image projection apparatus 100 is installed on the ceiling CE side and the image is projected downward, but as an alternative, the image projection apparatus 100 may be installed on the floor side and the image may be projected obliquely upward. In addition, the image projection apparatus 100 may be installed on a side wall (right side wall or left side wall) side of a room, and an image may be obliquely projected in a lateral direction (left direction or right direction).

FIGS. 12A and 12B are views for explaining the definitions of the variables of formula (6), FIG. 12A illustrates a YZ cross-sectional view, and FIG. 12B illustrates a ZX cross-sectional view. Assuming that D is a distance between the screen SR and the optical system of the image projection apparatus 100, that H is a length in the second direction perpendicular to the vertical direction to the magnification conjugate point perpendicular to the optical axis OA in the effective region where all light rays are projected on the screen SR, that V is a length in the first direction parallel to the vertical direction in the effective region where the all light rays are projected on the screen SR, and that SF is a vertical distance from the optical axis OA to the center of the length in the first direction of the effective region, the optical system can satisfy formula (6). With such a configuration, it is possible to realize a configuration in which the projection distance D to the screen SR is small (so-called short-focus projection) and the vertical distance SF is large (so-called super-shift projection).

In the optical system according to the present embodiment, a first footprint region on the second reflection surface of the first light flux LF1 on the first transmission surface may overlap a second footprint region on the second reflection surface of a second light flux farthest from the optical axis on the first transmission surface.

As illustrated in FIG. 5B, the first light flux LF1 closest to the optical axis OA on the first transmission surface T1 forms the first footprint region FP1 on the second reflection surface R2. In addition, the second light flux LF2 farthest from the optical axis OA on the first transmission surface T1 forms the second footprint region FP2 on the second reflection surface R2. In this case, by performing optical design so that the entire first footprint region FP1 overlaps the second footprint region FP2 on the second reflection surface R2, the area for the second footprint region FP2 can be reduced to reduce the size of the second reflection surface R2, and the increase in size of the prism PM in the Y direction can also be suppressed. In addition, even when only a part of the first footprint region FP1 overlaps the second footprint region FP2 on the second reflection surface R2, the area of the second footprint region FP2 overlapping the first footprint region FP1 can be reduced to reduce the size of the second reflection surface R2, and the increase in size of the prism PM in the Y direction can also be suppressed.

In addition, the optical system according to the present embodiment is an optical system having a reduction conjugate point on a reduction side and a magnification conjugate point on a magnification side, and having an intermediate imaging position conjugated with each of the reduction conjugate point and the magnification conjugate point inside,
the optical system includes:
a first sub-optical system including a plurality of lenses arranged along an optical axis in a Z direction, and an aperture stop between two lenses among the plurality of lenses; and
a second sub-optical system disposed closer to the magnification side than the first sub-optical system and including a prism PM having a plurality of optical surfaces, in which
the prism PM includes: as the plurality of optical surfaces,
   a first transmission surface T1 located on a reduction side,
   a second transmission surface T2 located on a magnification side; and
   a reflection surface group including a plurality of reflection surfaces having a first reflection surface R2 and a second reflection surface R2 located between the first transmission surface and the second transmission surface in a Y direction perpendicular to the Z direction, and located in order of an optical path from the first transmission surface T1 to the second transmission surface T2,
a light flux travels in a YZ surface including the Z direction and the Y direction inside the prism PM,
the intermediate imaging position of a first light flux LF1 closest to the optical axis is disposed between the first transmission surface T1 and the first reflection surface R2,
the second transmission surface T2 has a shape with a convex surface facing the magnification side, and a reflection surface located on a most magnification side in the reflection surface group has a convex shape with respect to the inside of the prism PM,
the reduction conjugate point has a rectangular region having a first direction and a second direction, a plane surface including a position where a principal ray of the first light flux LF1 in the rectangular region reflects off the first reflection surface R1 and the optical axis OA of the first sub-optical system is defined as a Y cross section, and a light flux farthest from the optical axis OA of the first sub-optical system on a line where the Y cross section and the rectangular region intersect is defined as a second light flux LF2, a first footprint region FP1 of the first light flux LF1 overlaps a second footprint region FP2 of the second light flux LF2 on the second reflection surface R2.

As illustrated in FIG. 17, the prism PM has, as the optical surface, the first transmission surface T1, the first reflection surface R1, the second reflection surface R2, the third reflection surface R3, and the second transmission surface T2 in order from the reduction side to the magnification side. Here, the prism PM having three reflection surfaces R1 to R3 is exemplified, but the prism PM may have one, two, or four or more reflection surfaces. The first light flux LF1 passing through the point closest to the optical axis OA forms the first footprint region FP1 on the second reflection surface R2. The second light flux LF2 passing through the point farthest from the optical axis OA forms the second footprint region FP2 on the second reflection surface R2. In this case, as illustrated in FIG. 18A, by performing optical design so that the entire first footprint region FP1 overlaps the second footprint region FP2 on the second reflection surface R2, the area for the second footprint region FP2 can be reduced to reduce the size of the second reflection surface R2, and the increase in size of the prism PM in the Y direction can also be suppressed. In addition, even when only a part of the first footprint region FP1 overlaps the second footprint region FP2 on the second reflection surface R2, the area of the second footprint region FP2 overlapping the first footprint region FP1 can be reduced to reduce the size of the second reflection surface R2, and the increase in size of the prism PM in the Y direction can also be suppressed.

In the optical system according to the present embodiment, when a position at which a principal ray of the first light flux LF1 reflects is defined as Y1, the first reflection surface R1 may have a curved surface shape that gives positive power at the Y1.

As illustrated in FIG. 17, at a position Y1 where the principal ray of the first light flux LF1 passing through the point closest to the optical axis OA reflects, the first reflection surface R1 has a curved surface shape that gives positive power P1. This can reduce the size of the first footprint region FP1 formed by the first light flux LF1 on the second reflection surface R2. As a result, the prism PM can be downsized.

In the optical system according to the present embodiment, when a position where the principal ray of the second light flux FL2 reflects is defined as Y2, the first reflection surface R1 may have a curved surface shape in which the power given at the Y2 is smaller than the positive power given at the Y1.

As illustrated in FIG. 17, at the position Y2 where the principal ray of the second light flux LF2 passing through the point farthest from the optical axis OA reflects, the first reflection surface R1 has positive or negative power P2 smaller than the positive power P1 according to the first light flux LF1. This makes the size of the second footprint region FP2 formed by the second light flux LF2 on the second reflection surface R2 larger than the size of the first footprint region FP1. As a result, optical performance at a low slow ratio can be secured.

In the optical system according to the present embodiment, the first reflection surface R1 may have a curved surface shape to which negative power is given at the Y2.

As illustrated in FIG. 17, the first reflection surface R1 has negative power P2 at the position Y2. This makes the size of the second footprint region FP2 formed by the second light flux LF2 on the second reflection surface R2 larger than the size of the first footprint region FP1. As a result, optical performance at a low slow ratio can be secured. With respect to the curved surface shape of the first reflection surface R1, as an example, as illustrated in FIG. 20, a range in which the second derivative value of the sag height change on the Y cross section is a positive value indicates the negative power P2, and a range in which the second derivative value is a negative value indicates the positive power P1. Such a curved surface shape can be designed as a free-form surface shape defined by (Math 2) and (Math 3) to be described later.

The optical system according to the present embodiment may have the third reflection surface R3 on an optical path between the second reflection surface R2 and the second transmission surface T1.

As illustrated in FIG. 17, the prism PM has three reflective surfaces R1 to R3 on an optical path between the first transmission surface T1 and the second transmission surface T2. As a result, both downsizing of the prism and a low slow ratio can be achieved.

In the optical system according to the present embodiment, the second reflection surface R2 may have a concave shape with respect to the inside of the prism, and the third reflection surface R3 may be a reflection surface on a most magnification side in the reflection surface group. The third reflection surface R3 may have a convex shape with respect to the inside of the prism.

As illustrated in FIG. 17, since the second reflection surface R2 has a concave shape with respect to the inside of the prism, the second reflection surface R2 functions to focus the light flux. On the other hand, since the third reflection surface R3 has a convex shape with respect to the inside of the prism, the third reflection surface R3 functions to diverge the light flux. As a result, both downsizing of the prism and a low slow ratio can be achieved.

In the optical system according to the present embodiment, on the Y cross section, the first footprint region FP1 may be located within a range of the center 70% of the second footprint region FP2.

As illustrated in FIG. 18A, when the longitudinal size of the second footprint region FP2 is defined as A, the first footprint region FP1 is included within a range of −A×35% to +A×35% from the center of the second footprint region FP2. As a result, the size of the second reflection surface R2 can be reduced, and the prism can be downsized.

In the optical system according to the present embodiment, on the Y cross section, the size ratio of the second footprint region FP to the first footprint region FP may be 20% or less.

As illustrated in FIG. 18B, when the longitudinal size of the second footprint region FP2 is defined as A, the longitudinal size of the first footprint region FP1 is set to A×20% or less. As a result, the size of the second reflection surface R2 can be reduced, and the prism can be downsized.

The optical system according to the present embodiment includes the third reflection surface R3 on an optical path between the second reflection surface R2 and the second transmission surface T2, and on the third reflection surface R3, the third footprint region FP3 of the first light flux LF1 is located closer to the optical axis OA of the first sub-optical system than the fourth footprint region FP4 of the second light flux LF2, and
on the Y cross section, the size ratio of the third footprint region FP3 to the fourth footprint region FP4 may be 20% or less.

As illustrated in FIG. 19, the first light flux LF1 passing through the point closest to the optical axis OA forms the third footprint region FP3 on the third reflection surface R3. The second light flux LF2 passing through the point farthest from the optical axis OA forms the fourth footprint region FP4 on the third reflection surface R3. In this case, the third footprint region FP3 is located closer to the optical axis OA than the fourth footprint region FP4, and the longitudinal size of the third footprint region FP3 is set to B×20% or less when the longitudinal size of the fourth footprint region FP4 is defined as B. As a result, the size of the second reflection surface R2 can be reduced, and the prism can be downsized.

In the optical system according to the present embodiment, in a case where the prism PM is viewed from the first sub-optical system, the prism PM may have a shape in which the second reflection surface R2 is located between the first transmission surface T1 and the second transmission surface T2 on the Y cross section.

As illustrated in FIGS. 14A to 14C, the first transmission surface T1, the second reflection surface R2, and the second transmission surface T2 are disposed on the front side of the prism PM, and the first reflection surface R1 and the second reflection surface R2 are disposed on the rear side of the prism PM. In a case where this optical system is used in the image projection apparatus, it is possible to realize rear surface projection in which image light from an image forming element is made incident on the first transmission surface T1 and is emitted obliquely upward from the second transmission surface T2.

Hereinafter, numerical examples of the optical system according to the first to third examples will be described. Note that, in each numerical example, the unit of the length in the table is all “mm”, and the unit of the angle of view is all “°”. In addition, in each numerical example, an object height (XY polynomial surface, spherical surface, aspherical surface), a curvature radius, a surface interval, a d-line refractive index, a d-line Abbe number, a material, refraction/reflection, an eccentric type, and a Y eccentricity are illustrated. In addition, various amounts of the numerical examples are calculated based on a wavelength of 550 nm. In addition, in each numerical example, the shape of the aspherical surface is defined by the following formula. Note that, as the aspherical coefficient, only a coefficient that is not 0 except a conic constant k is described.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} \qquad [ Math 1 ]$$

Here,
z is a sag height of a surface parallel to z axis,
r is a distance in radial direction (=a square root of (x²+y²)),
c is curvature at surface vertex,
k is a conic constant, and
A to H are 4th to 18th order aspherical coefficients of r.

In addition, the free-form surface shape is defined by the following formula using a local orthogonal coordinate system (x, y, z) with the surface vertex as an origin.

$$z = \frac{c {r}^{2}}{1 + \sqrt{1 - ( 1 + k ) {c}^{2} {r}^{2}}} + {\sum }_{j = 2}^{137} {C}_{j} {x}^{m} {y}^{n} \qquad [ Math 2 ]$$

$$j = \frac{{( m + n )}^{2} + m + 3 n}{2} + 1 \qquad [ Math 3 ]$$

Here,
z is a sag height of surface parallel to z axis,
r is a distance in radial direction (=a square root of (x²+y²)),
c is curvature at surface vertex,
k is a conic constant, and
Cⱼ is a coefficient of monomial x^{m}yⁿ.

Note that, in each of the following data, an i-th order term of x and a j-th order term of y, which are free-form surface coefficients in the polynomial, are described as x**i*y**j. For example, “X**2*Y” indicates a free-form surface coefficient of a second order term of x and a first order term of y in the polynomial.

### First Numerical Example

For the optical system of a first numerical example (corresponding to the first example), the lens data is illustrated in Table 1, the aspherical shape data of the lens is illustrated in Table 2, and the free-form surface shape data of the prism is illustrated in Table 3. Note that, “decenter and return (DAR)” in Table 1 means coordinate conversion between a global coordinate and a local coordinate at the time of numerical calculation. The same applies to other numerical examples.

TABLE 1

| | Surface | Object | Curvature | | Refractive | Abbe | | Refraction/ | Eccentric | Y |
|---|---|---|---|---|---|---|---|---|---|---|
| | number | height | radius | Interval | index | number | Material | Reflection | type | eccentricity |
| SR | S0 | | | 1131 | | | | | | |
| T2 | S1 | XY polynomial | −305.943 | 17.150 | 1.587 | 59.013 | KSKLD200 | Refraction | DAR | −19.5173 |
| | | surface | | | | | | | | |
| R2 | S2 | XY polynomial | 592.585 | −30.000 | 1.587 | 59.013 | KSKLD200 | Reflection | DAR | −19.2736 |
| | | surface | | | | | | | | |
| R1 | S3 | XY polynomial | 348.852 | 28.171 | 1.587 | 59.013 | KSKLD200 | Reflection | DAR | −13.1971 |
| | | surface | | | | | | | | |
| T1 | S4 | XY polynomial | −24.910 | 62.178 | | | | Refraction | DAR | 9.95137 |
| | | surface | | | | | | | | |
| L7 | S5 | Sphere | −157.621 | 3.000 | 1.847 | 23.784 | FDS90SG | Refraction | | |
| L7 | S6 | Sphere | 249.158 | 6.003 | | | | Refraction | | |
| L6 | S7 | Sphere | −162.392 | 12.328 | 1.859 | 29.997 | NBFD30 | Refraction | | |
| L6 | S8 | Sphere | −62.086 | 27.204 | | | | Refraction | | |
| L5 | S9 | Sphere | 244.013 | 15.128 | 1.487 | 70.235 | SFSL5 | Refraction | | |
| L5 | S10 | Sphere | −85.418 | 60.743 | | | | Refraction | | |
| | S11 | Sphere | ∞ | 20.000 | | | | Refraction | | |
| ST | S12 | Sphere | ∞ | 2.252 | | | | Refraction | | |
| Aperture | | | | | | | | | | |
| stop | | | | | | | | | | |
| L4 | S13 | Sphere | 36.866 | 6.172 | 1.497 | 81.607 | FCD1 | Refraction | | |
| L4 | S14 | Sphere | −61.562 | 3.690 | | | | Refraction | | |
| L3 | S15 | Sphere | −45.653 | 1.500 | 1.738 | 32.326 | SNBH53V | Refraction | | |
| L3 | S16 | Sphere | 59.821 | 26.671 | | | | Refraction | | |
| L2 | S17 | Aspherical | 113.913 | 6.816 | 1.587 | 59.013 | KSKLD200 | Refraction | | |
| | | surface | | | | | | | | |
| L2 | S18 | Aspherical | −72.276 | 0.200 | | | | Refraction | | |
| | | surface | | | | | | | | |
| L1 | S19 | Sphere | 941.815 | 11.890 | 1.497 | 81.607 | FCD1 | Refraction | | |
| L1 | S20 | Sphere | −39.734 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −666 |
| f2 | 0.000 | −8.100 | 0 | −1841 |
| f3 | 0.000 | −14.418 | 0 | −3037 |
| f4 | −8.640 | −1.782 | −1616 | −672 |
| f5 | −8.640 | −8.100 | −1624 | −1841 |
| f6 | −8.640 | −14.418 | −1624 | −3042 |

Aperture diameter

| | |
|---|---|
| S11 | 28.008 |
| Aperture stop | 24.136 |
| S16 | 21.605 |

Display element size

| | |
|---|---|
| Long side | 17.28 |
| Short side | 10.8 |
| Display element shift range | −7.182~−9.018 |

TABLE 2
Aspherical coefficient

| S17 | | S18 | |
|---|---|---|---|
| Conic constant (K) | 0.00000E+00 | Conic constant (K) | 0.00000E+00 |
| Fourth order coefficient (A) | −2.18375E−06 | Fourth order coefficient (A) | 3.53097E−06 |
| Sixth order coefficient (B) | −8.46633E−10 | Sixth order coefficient (B) | 0.00000E+00 |
| Eighth order coefficient (C) | 0.00000E+00 | Eighth order coefficient (C) | 0.00000E+00 |
| Tenth order coefficient (D) | 0.00000E+00 | Tenth order coefficient (D) | 0.00000E+00 |

TABLE 3
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.50811E−02 | 0.00000E+00 | 6.26690E−06 | 0.00000E+00 | −3.45326E−09 | 0.00000E+00 | 3.17778E−11 | 0.00000E+00 | −3.58947E−14 |
| Y**1 | −4.87977E−01 | 0.00000E+00 | −3.92703E−04 | 0.00000E+00 | −1.88726E−07 | 0.00000E+00 | −3.49237E−10 | 0.00000E+00 | −6.91372E−13 | 0.00000E+00 | |
| Y**2 | 2.18847E−02 | 0.00000E+00 | 1.89724E−05 | 0.00000E+00 | 2.94062E−08 | 0.00000E+00 | 9.16657E−11 | 0.00000E+00 | −8.34204E−17 | | |
| Y**3 | −5.27660E−04 | 0.00000E+00 | −5.32089E−07 | 0.00000E+00 | −2.32093E−09 | 0.00000E+00 | −7.46087E−12 | 0.00000E+00 | | | |
| Y**4 | 8.49779E−06 | 0.00000E+00 | 1.61259E−07 | 0.00000E+00 | 2.12787E−11 | 0.00000E+00 | 3.74642E−13 | | | | |
| Y**5 | −1.07758E−06 | 0.00000E+00 | −1.49769E−10 | 0.00000E+00 | −3.45702E−11 | 0.00000E+00 | | | | | |
| Y**6 | 1.74131E−07 | 0.00000E+00 | −6.91429E−10 | 0.00000E+00 | 2.72016E−12 | | | | | | |
| Y**7 | 2.75488E−09 | 0.00000E+00 | −6.03658E−11 | 0.00000E+00 | | | | | | | |
| Y**8 | −9.34846E−10 | 0.00000E+00 | 6.01946E−12 | | | | | | | | |
| Y**9 | −3.98296E−11 | 0.00000E+00 | | | | | | | | | |
| Y**10 | 4.38520E−12 | | | | | | | | | | |
| S2 | | | | | | | | | | | |
| Y**0 | | 0.00000E+00 | −6.02011E−04 | 0.00000E+00 | 4.74904E−06 | 0.00000E+00 | 0.00000E+00 | 0.00000E+00 | 0.00000E+00 | 0.00000E+00 | 0.00000E+00 |
| Y**1 | −5.28258E−02 | 0.00000E+00 | −4.42038E−05 | 0.00000E+00 | −3.81142E−07 | 0.00000E+00 | 0.00000E+00 | 0.00000E+00 | 0.00000E+00 | 0.00000E+00 | |
| Y**2 | −1.82294E−04 | 0.00000E+00 | 3.86661E−06 | 0.00000E+00 | 0.00000E+00 | 0.00000E+00 | 0.00000E+00 | 0.00000E+00 | 0.00000E+00 | | |
| Y**3 | −3.12334E−05 | 0.00000E+00 | −8.31133E−08 | 0.00000E+00 | 0.00000E+00 | 0.00000E+00 | 0.00000E+00 | 0.00000E+00 | | | |
| Y**4 | 6.33979E−07 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 9.41512E−03 | 0.00000E+00 | 4.22391E−05 | 0.00000E+00 | −1.97582E−07 | 0.00000E+00 | 3.46385E−10 | 0.00000E+00 | −2.23292E−13 |
| Y**1 | −2.36356E−01 | 0.00000E+00 | −2.17982E−04 | 0.00000E+00 | 5.07070E−07 | 0.00000E+00 | 4.91933E−10 | 0.00000E+00 | 0.00000E+00 | 0.00000E+00 | |
| Y**2 | 2.49941E−02 | 0.00000E+00 | 1.12757E−05 | 0.00000E+00 | −1.08501E−07 | 0.00000E+00 | 1.67161E−10 | 0.00000E+00 | −1.68870E−13 | | |
| Y**3 | −1.12004E−03 | 0.00000E+00 | 2.33691E−07 | 0.00000E+00 | 1.88363E−09 | 0.00000E+00 | 0.00000E+00 | 0.00000E+00 | | | |
| Y**4 | 2.58788E−05 | 0.00000E+00 | −2.06327E−08 | 0.00000E+00 | −7.37892E−12 | 0.00000E+00 | −3.78627E−14 | | | | |
| Y**5 | 2.94396E−07 | 0.00000E+00 | 4.18271E−10 | 0.00000E+00 | 0.00000E+00 | 0.00000E+00 | | | | | |
| Y**6 | −1.67861E−08 | 0.00000E+00 | −4.98296E−12 | 0.00000E+00 | 0.00000E+00 | | | | | | |
| Y**7 | −7.54499E−11 | 0.00000E+00 | 0.00000E+00 | 0.00000E+00 | | | | | | | |
| Y**8 | 6.48916E−12 | 0.00000E+00 | 0.00000E+00 | | | | | | | | |
| Y**9 | 0.00000E+00 | 0.00000E+00 | | | | | | | | | |
| Y**10 | −1.03332E−15 | | | | | | | | | | |
| S4 | | | | | | | | | | | |
| Y**0 | | 0.00000E+00 | 2.14545E−02 | 0.00000E+00 | 1.25935E−04 | 0.00000E+00 | −9.76665E−07 | 0.00000E+00 | 3.11269E−09 | 0.00000E+00 | −3.39591E−12 |
| Y**1 | 1.50130E−01 | 0.00000E+00 | −1.55014E−03 | 0.00000E+00 | 2.45075E−06 | 0.00000E+00 | −2.58417E−09 | 0.00000E+00 | 0.00000E+00 | 0.00000E+00 | |
| Y**2 | 2.15699E−02 | 0.00000E+00 | 2.79773E−05 | 0.00000E+00 | −8.18191E−08 | 0.00000E+00 | 6.16416E−10 | 0.00000E+00 | −1.04253E−12 | | |
| Y**3 | −1.93003E−03 | 0.00000E+00 | 1.13503E−06 | 0.00000E+00 | 8.47425E−10 | 0.00000E+00 | 0.00000E+00 | 0.00000E+00 | | | |
| Y**4 | 1.10859E−05 | 0.00000E+00 | 2.65338E−07 | 0.00000E+00 | −1.67008E−09 | 0.00000E+00 | 2.70718E−12 | | | | |
| Y**5 | 9.22577E−06 | 0.00000E+00 | 5.48155E−09 | 0.00000E+00 | 0.00000E+00 | 0.00000E+00 | | | | | |
| Y**6 | −4.33537E−07 | 0.00000E+00 | −1.45971E−09 | 0.00000E+00 | 2.39933E−12 | | | | | | |
| Y**7 | −1.19514E−09 | 0.00000E+00 | 0.00000E+00 | 0.00000E+00 | | | | | | | |
| Y**8 | 2.89623E−10 | 0.00000E+00 | 1.76050E−12 | | | | | | | | |
| Y**9 | 0.00000E+00 | 0.00000E+00 | | | | | | | | | |
| Y**10 | 0.00000E+00 | | | | | | | | | | |

### Second Numerical Example

For the optical system of a second numerical example (corresponding to the second example), the lens data is illustrated in Table 4, the aspherical shape data of the lens is illustrated in Table 5, and the free-form surface shape data of the prism is illustrated in Table 6.

TABLE 4

| | Surface | Object | Curvature | | Refractive | Abbe | | Refraction/ | Eccentric | Y |
|---|---|---|---|---|---|---|---|---|---|---|
| | number | height | radius | Interval | index | number | Material | Reflection | type | eccentricity |
| SR | S0 | | | 1131 | | | | | | |
| T2 | S1 | XY polynomial | 208.732 | 17.258 | 1.589 | 61.264 | KSKLD5 | Refraction | DAR | 1.238 |
| | | surface | | | | | | | | |
| R2 | S2 | XY polynomial | 334.249 | −25.488 | 1.589 | 61.264 | KSKLD5 | Reflection | DAR | −19.848 |
| | | surface | | | | | | | | |
| R1 | S3 | XY polynomial | 49.057 | 27.862 | 1.589 | 61.264 | KSKLD5 | Reflection | DAR | −15.301 |
| | | surface | | | | | | | | |
| T1 | S4 | XY polynomial | −43.116 | 15.970 | | | | Refraction | DAR | −5.793 |
| | | surface | | | | | | | | |
| L7 | S5 | Sphere | −122.211 | 3.000 | 1.847 | 23.784 | FDS90SG | Refraction | | |
| L7 | S6 | Sphere | 777.948 | 9.172 | | | | Refraction | | |
| L6 | S7 | Sphere | −104.570 | 18.305 | 1.702 | 41.148 | BAFD7 | Refraction | | |
| L6 | S8 | Sphere | −51.966 | 23.156 | | | | Refraction | | |
| L5 | S9 | Sphere | −314.756 | 15.416 | 1.729 | 54.673 | TAC8 | Refraction | | |
| L5 | S10 | Sphere | −75.990 | 70.551 | | | | Refraction | | |
| | S11 | Sphere | ∞ | 15.000 | | | | Refraction | | |
| ST | S12 | Sphere | ∞ | 12.289 | | | | Refraction | | |
| Aperture | | | | | | | | | | |
| stop | | | | | | | | | | |
| L4 | S13 | Sphere | 39.314 | 9.226 | 1.437 | 95.099 | FCD100 | Refraction | | |
| L4 | S14 | Sphere | −34.812 | 2.937 | | | | Refraction | | |
| L3 | S15 | Sphere | −28.242 | 1.500 | 1.673 | 38.255 | SNBH52V | Refraction | | |
| L3 | S16 | Sphere | 78.147 | 10.561 | | | | Refraction | | |
| L2 | S17 | Aspherical | 89.227 | 11.291 | 1.589 | 61.264 | ‘KSKLD5’ | Refraction | | |
| | | surface | | | | | | | | |
| L2 | S18 | Aspherical | −42.016 | 0.399 | | | | Refraction | | |
| | | surface | | | | | | | | |
| L1 | S19 | Sphere | −262.410 | 12.825 | 1.437 | 95.099 | FCD100 | Refraction | | |
| L1 | S20 | Sphere | −33.131 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −666 |
| f2 | 0.000 | −8.100 | 0 | −1846 |
| f3 | 0.000 | −14.418 | 0 | −3038 |
| f4 | −8.640 | −1.782 | −1616 | −673 |
| f5 | −8.640 | −8.100 | −1617 | −1841 |
| f6 | −8.640 | −14.418 | −1614 | −3056 |

Aperture diameter

| | |
|---|---|
| S11 | 23.435 |
| Aperture stop | 21.194 |
| S13 | 24.381 |
| S16 | 26.026 |

Display element size

| | |
|---|---|
| Long side | 17.28 |
| Short side | 10.8 |
| Display element shift range | −7.182~−9.018 |

TABLE 5
Aspherical coefficient

| S17 | | S18 | |
|---|---|---|---|
| Conic constant (K) | 0.00000E+00 | Conic constant (K) | 0.00000E+00 |
| Fourth order coefficient (A) | −2.97040E−06 | Fourth order coefficient (A) | 5.52053E−06 |
| Sixth order coefficient (B) | 4.21560E−09 | Sixth order coefficient (B) | 4.28853E−09 |
| Eighth order coefficient (C) | 1.45432E−11 | Eighth order coefficient (C) | 8.23116E−12 |
| Tenth order coefficient (D) | −2.31318E−15 | Tenth order coefficient (D) | 1.78431E−14 |

TABLE 6
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 3.63759E−03 | 0.00000E+00 | 7.24438E−06 | 0.00000E+00 | 4.62196E−09 | 0.00000E+00 | 0.00000E+00 | 0.00000E+00 | 0.00000E+00 |
| Y**1 | 6.16957E−01 | 0.00000E+00 | −1.32516E−03 | 0.00000E+00 | 1.31591E−06 | 0.00000E+00 | 1.92461E−11 | 0.00000E+00 | 0.00000E+00 | 0.00000E+00 | |
| Y**2 | 5.63827E−02 | 0.00000E+00 | −9.84795E−05 | 0.00000E+00 | 8.62347E−08 | 0.00000E+00 | −2.54786E−11 | 0.00000E+00 | 0.00000E+00 | | |
| Y**3 | 1.49481E−03 | 0.00000E+00 | −1.89079E−06 | 0.00000E+00 | −1.30806E−10 | 0.00000E+00 | −5.16530E−13 | 0.00000E+00 | | | |
| Y**4 | 4.24651E−06 | 0.00000E+00 | 5.37511E−08 | 0.00000E+00 | −9.59539E−11 | 0.00000E+00 | 1.93980E−14 | | | | |
| Y**5 | −2.32493E−07 | 0.00000E+00 | 9.84845E−11 | 0.00000E+00 | 2.87775E−13 | 0.00000E+00 | | | | | |
| Y**6 | 1.92481E−08 | 0.00000E+00 | −7.42886E−11 | 0.00000E+00 | 6.28246E−14 | | | | | | |
| Y**7 | 5.58656E−12 | 0.00000E+00 | −1.34651E−13 | 0.00000E+00 | | | | | | | |
| Y**8 | −1.93690E−11 | 0.00000E+00 | 3.04924E−14 | | | | | | | | |
| Y**9 | 1.77736E−15 | 0.00000E+00 | | | | | | | | | |
| Y**10 | 6.89638E−15 | | | | | | | | | | |
| S2 | | | | | | | | | | | |
| Y**0 | | 0.00000E+00 | −1.90415E−03 | 0.00000E+00 | −1.03904E−06 | 0.00000E+00 | 0.00000E+00 | 0.00000E+00 | 0.00000E+00 | 0.00000E+00 | 0.00000E+00 |
| Y**1 | −9.02833E−03 | 0.00000E+00 | −5.86052E−05 | 0.00000E+00 | −3.15755E−08 | 0.00000E+00 | 0.00000E+00 | 0.00000E+00 | 0.00000E+00 | 0.00000E+00 | |
| Y**2 | −1.75410E−03 | 0.00000E+00 | 1.02509E−05 | 0.00000E+00 | 3.03769E−08 | 0.00000E+00 | 0.00000E+00 | 0.00000E+00 | 0.00000E+00 | | |
| Y**3 | −7.62818E−06 | 0.00000E+00 | −1.64370E−06 | 0.00000E+00 | −2.63595E−09 | 0.00000E+00 | 0.00000E+00 | 0.00000E+00 | | | |
| Y**4 | −7.32083E−07 | 0.00000E+00 | 1.50958E−07 | 0.00000E+00 | −1.57413E−10 | 0.00000E+00 | 0.00000E+00 | | | | |
| Y**5 | 3.49806E−09 | 0.00000E+00 | −7.38150E−09 | 0.00000E+00 | 2.58599E−11 | 0.00000E+00 | | | | | |
| Y**6 | 2.83743E−09 | 0.00000E+00 | 1.84382E−10 | 0.00000E+00 | −7.07205E−13 | | | | | | |
| Y**7 | −5.80354E−11 | 0.00000E+00 | −3.42641E−12 | 0.00000E+00 | | | | | | | |
| Y**8 | −1.30372E−12 | 0.00000E+00 | 9.21081E−14 | | | | | | | | |
| Y**9 | −1.13440E−13 | 0.00000E+00 | | | | | | | | | |
| Y**10 | 5.37125E−15 | | | | | | | | | | |
| S3 | | | | | | | | | | | |
| Y**0 | | 0.00000E+00 | 7.46960E−03 | 0.00000E+00 | −1.19869E−05 | 0.00000E+00 | −6.18875E−08 | 0.00000E+00 | 1.03224E−10 | 0.00000E+00 | −3.20719E−15 |
| Y**1 | −9.66513E−01 | 0.00000E+00 | −6.10855E−05 | 0.00000E+00 | 1.91296E−06 | 0.00000E+00 | 3.59881E−09 | 0.00000E+00 | −7.19434E−12 | 0.00000E+00 | |
| Y**2 | 6.60041E−02 | 0.00000E+00 | −3.03122E−05 | 0.00000E+00 | −7.19123E−08 | 0.00000E+00 | −5.24817E−11 | 0.00000E+00 | 1.25919E−13 | | |
| Y**3 | −2.55295E−03 | 0.00000E+00 | 1.42809E−06 | 0.00000E+00 | −7.08555E−10 | 0.00000E+00 | 4.54227E−13 | 0.00000E+00 | | | |
| Y**4 | 3.54812E−05 | 0.00000E+00 | −1.86492E−08 | 0.00000E+00 | 5.56270E−11 | 0.00000E+00 | −2.01960E−14 | | | | |
| Y**5 | 3.11157E−07 | 0.00000E+00 | −6.17236E−11 | 0.00000E+00 | −1.19430E−13 | 0.00000E+00 | | | | | |
| Y**6 | −1.14347E−08 | 0.00000E+00 | −3.16079E−12 | 0.00000E+00 | −1.25093E−14 | | | | | | |
| Y**7 | 1.34648E−11 | 0.00000E+00 | 5.93739E−14 | 0.00000E+00 | | | | | | | |
| Y**8 | 1.97329E−13 | 0.00000E+00 | −5.88263E−16 | | | | | | | | |
| Y**9 | 3.05462E−15 | 0.00000E+00 | | | | | | | | | |
| Y**10 | −4.40930E−17 | | | | | | | | | | |
| S4 | | | | | | | | | | | |
| Y**0 | | 0.00000E+00 | 4.36442E−02 | 0.00000E+00 | −1.02944E−04 | 0.00000E+00 | 1.28062E−07 | 0.00000E+00 | 0.00000E+00 | 0.00000E+00 | 0.00000E+00 |
| Y**1 | −9.87034E−01 | 0.00000E+00 | −1.86234E−03 | 0.00000E+00 | 1.06512E−05 | 0.00000E+00 | −1.29879E−08 | 0.00000E+00 | 0.00000E+00 | 0.00000E+00 | |
| Y**2 | 1.57522E−01 | 0.00000E+00 | −3.08072E−05 | 0.00000E+00 | −4.12931E−07 | 0.00000E+00 | 3.02223E−10 | 0.00000E+00 | 0.00000E+00 | | |
| Y**3 | −9.94031E−03 | 0.00000E+00 | 6.07723E−06 | 0.00000E+00 | 5.34511E−09 | 0.00000E+00 | 3.81454E−12 | 0.00000E+00 | | | |
| Y**4 | 2.53596E−04 | 0.00000E+00 | −8.33006E−08 | 0.00000E+00 | 7.84892E−11 | 0.00000E+00 | −1.58495E−13 | | | | |
| Y**5 | 3.35160E−06 | 0.00000E+00 | −9.98592E−09 | 0.00000E+00 | −1.24280E−12 | 0.00000E+00 | | | | | |
| Y**6 | −2.38288E−07 | 0.00000E+00 | 3.27815E−10 | 0.00000E+00 | −2.02073E−14 | | | | | | |
| Y**7 | −1.57225E−10 | 0.00000E+00 | −7.15380E−14 | 0.00000E+00 | | | | | | | |
| Y**8 | 9.78514E−11 | 0.00000E+00 | −6.27602E−14 | | | | | | | | |
| Y**9 | 5.73216E−14 | 0.00000E+00 | | | | | | | | | |
| Y**10 | −2.03739E−14 | | | | | | | | | | |

### Third Numerical Example

For the optical system of a third numerical example (corresponding to the third example), the lens data is illustrated in Table 7, the aspherical shape data of the lens is illustrated in Table 8, and the free-form surface shape data of the prism is illustrated in Table 9.

TABLE 7

| | Surface | Object | Curvature | | Refractive | Abbe | | Refraction/ | Eccentric | Y |
|---|---|---|---|---|---|---|---|---|---|---|
| | number | height | radius | Interval | index | number | Material | Reflection | type | eccentricity |
| SR | S0 | | | 1131 | | | | | | |
| T2 | S1 | XY polynomial | 185.512 | 19.248 | 1.589 | 61.264 | KSKLD5 | Refraction | DAR | −0.927 |
| | | surface | | | | | | | | |
| R2 | S2 | XY polynomial | 490.660 | −22.437 | 1.589 | 61.264 | KSKLD5 | Reflection | DAR | −22.539 |
| | | surface | | | | | | | | |
| R1 | S3 | XY polynomial | 49.269 | 27.545 | 1.589 | 61.264 | KSKLD5 | Reflection | DAR | −17.682 |
| | | surface | | | | | | | | |
| T1 | S4 | XY polynomial | −49.870 | 9.011 | | | | Refraction | DAR | −7.481 |
| | | surface | | | | | | | | |
| L7 | SS | Sphere | −147.363 | 3.000 | 1.847 | 23.784 | FDS90SG | Refraction | | |
| L7 | S6 | Sphere | 212.890 | 10.585 | | | | Refraction | | |
| L6 | S7 | Sphere | −106.174 | 18.846 | 1.835 | 42.721 | TAFD5G | Refraction | | |
| L6 | S8 | Sphere | −49.421 | 17.202 | | | | Refraction | | |
| L5 | SS | Sphere | −258.405 | 20.358 | 1.487 | 70.440 | FC5 | Refraction | | |
| L5 | S10 | Sphere | −63.018 | 60.555 | | | | Refraction | | |
| | S11 | Sphere | ∞ | 15.000 | | | | Refraction | | |
| ST | S12 | Sphere | ∞ | 12.289 | | | | Refraction | | |
| Aperture | | | | | | | | | | |
| stop | | | | | | | | | | |
| L4 | S13 | Sphere | 39.314 | 9.226 | 1.437 | 95.099 | FCD100 | Refraction | | |
| L4 | S14 | Sphere | −34.812 | 2.937 | | | | Refraction | | |
| L3 | S15 | Sphere | −28.242 | 1.500 | 1.673 | 38.255 | SNBH52V | Refraction | | |
| L3 | S16 | Sphere | 78.147 | 10.561 | | | | Refraction | | |
| L2 | S17 | Aspherical | 85.752 | 11.291 | 1.589 | 61.264 | KSKLD5’ | Refraction | | |
| | | surface | | | | | | | | |
| L2 | S18 | Aspherical | −42.274 | 0.399 | | | | Refraction | | |
| | | surface | | | | | | | | |
| L1 | S19 | Sphere | −262.410 | 12.825 | 1.437 | 95.099 | FCD100 | Refraction | | |
| L1 | S20 | Sphere | −33.131 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −666 |
| f2 | 0.000 | −8.100 | 0 | −1842 |
| f3 | 0.000 | −14.418 | 0 | −3038 |
| f4 | −8.640 | −1.782 | −1616 | −667 |
| f5 | −8.640 | −8.100 | −1612 | −1841 |
| f6 | −8.640 | −14.418 | −1612 | −3047 |

Aperture diameter

| | |
|---|---|
| S11 | 23.435 |
| Aperture stop | 20 |
| S13 | 24.381 |
| S16 | 26.026 |

Display element size

| | |
|---|---|
| Long side | 17.28 |
| Short side | 10.8 |
| Display element shift range | −7.182~−9.018 |

TABLE 8
Aspherical coefficient

| S17 | | S18 | |
|---|---|---|---|
| Conic constant (K) | 0.00000E+00 | Conic constant (K) | 0.00000E+00 |
| Fourth order coefficient (A) | −3.40022E−06 | Fourth order coefficient (A) | 5.23037E−06 |
| Sixth order coefficient (B) | 4.50660E−09 | Sixth order coefficient (B) | 4.25660E−09 |
| Eighth order coefficient (C) | 1.38618E−11 | Eighth order coefficient (C) | 8.59843E−12 |
| Tenth order coefficient (D) | −3.17046E−15 | Tenth order coefficient (D) | 1.65893E−14 |
| Twelfth order coefficient (E) | −1.67546E−19 | Twelfth order coefficient (E) | −1.41083E−18 |
| Fourteenth order coefficient (F) | 6.29845E−22 | Fourteenth order coefficient (F) | −7.86002E−22 |

TABLE 9
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 3.33413E−03 | 0.00000E+00 | 4.82431E−06 | 0.00000E+00 | 1.81382E−08 | 0.00000E+00 | −7.82548E−12 | 0.00000E+00 | −4.02284E−15 |
| Y**1 | 6.62917E−01 | 0.00000E+00 | −1.39786E−03 | 0.00000E+00 | 1.58157E−06 | 0.00000E+00 | 1.27865E−09 | 0.00000E+00 | −1.19380E−12 | 0.00000E+00 | |
| Y**2 | 5.79351E−02 | 0.00000E+00 | −1.01796E−04 | 0.00000E+00 | 1.12005E−07 | 0.00000E+00 | 1.16785E−11 | 0.00000E+00 | −1.61297E−14 | | |
| Y**3 | 1.45241E−03 | 0.00000E+00 | −1.60109E−06 | 0.00000E+00 | −1.86434E−11 | 0.00000E+00 | 1.20979E−12 | 0.00000E+00 | | | |
| Y**4 | 4.06515E−06 | 0.00000E+00 | 5.65255E−08 | 0.00000E+00 | −1.01408E−10 | 0.00000E+00 | 5.30789E−14 | | | | |
| Y**5 | −7.50764E−08 | 0.00000E+00 | −1.40957E−10 | 0.00000E+00 | 3.74485E−13 | 0.00000E+00 | | | | | |
| Y**6 | 1.90203E−08 | 0.00000E+00 | −6.96363E−11 | 0.00000E+00 | 5.53563E−14 | | | | | | |
| Y**7 | −1.03531E−10 | 0.00000E+00 | −1.19642E−13 | 0.00000E+00 | | | | | | | |
| Y**8 | −1.90947E−11 | 0.00000E+00 | 2.27470E−14 | | | | | | | | |
| Y**9 | −3.61636E−14 | 0.00000E+00 | | | | | | | | | |
| Y**10 | 4.83173E−15 | | | | | | | | | | |
| S2 | | | | | | | | | | | |
| Y**0 | | 0.00000E+00 | −1.79516E−03 | 0.00000E+00 | 0.00000E+00 | 0.00000E+00 | 0.00000E+00 | 0.00000E+00 | 0.00000E+00 | 0.00000E+00 | 0.00000E+00 |
| Y**1 | −1.75325E−02 | 0.00000E+00 | −1.93676E−05 | 0.00000E+00 | 0.00000E+00 | 0.00000E+00 | 0.00000E+00 | 0.00000E+00 | 0.00000E+00 | 10.00000E+00 | |
| Y**2 | −1.42518E−03 | 0.00000E+00 | 5.03759E−06 | 0.00000E+00 | 0.00000E+00 | 0.00000E+00 | 0.00000E+00 | 0.00000E+00 | 0.00000E+00 | | |
| Y**3 | 1.04247E−06 | 0.00000E+00 | −1.28271E−06 | 0.00000E+00 | 0.00000E+00 | 0.00000E+00 | 0.00000E+00 | 0.00000E+00 | | | |
| Y**4 | −5.04820E−07 | 0.00000E+00 | 1.45646E−07 | 0.00000E+00 | 0.00000E+00 | 0.00000E+00 | 0.00000E+00 | | | | |
| Y**5 | −2.15735E−08 | 0.00000E+00 | −8.42405E−09 | 0.00000E+00 | 0.00000E+00 | 0.00000E+00 | | | | | |
| Y**6 | 1.73053E−09 | 0.00000E+00 | 2.19525E−10 | 0.00000E+00 | 0.00000E+00 | | | | | | |
| Y**7 | −6.08899E−11 | 0.00000E+00 | −4.90628E−13 | 0.00000E+00 | | | | | | | |
| Y**8 | 1.62220E−12 | 0.00000E+00 | −5.44873E−14 | | | | | | | | |
| Y**9 | 4.24661E−14 | 0.00000E+00 | | | | | | | | | |
| Y**10 | −2.53974E−15 | | | | | | | | | | |
| S3 | | | | | | | | | | | |
| Y**0 | | 0.00000E+00 | 1.03735E−02 | 0.00000E+00 | −1.79023E−05 | 0.00000E+00 | −2.85116E−08 | 0.00000E+00 | 3.44458E−11 | 0.00000E+00 | −2.64834E−15 |
| Y**1 | −1.23468E+00 | 0.00000E+00 | −2.82273E−04 | 0.00000E+00 | 1.95862E−06 | 0.00000E+00 | 2.33417E−09 | 0.00000E+00 | −2.50083E−12 | 0.00000E+00 | |
| Y**2 | 7.41446E−02 | 0.00000E+00 | −1.71339E−05 | 0.00000E+00 | −6.87974E−08 | 0.00000E+00 | −6.41617E−11 | 0.00000E+00 | 5.17951E−14 | | |
| Y**3 | −2.63116E−03 | 0.00000E+00 | 1.36668E−06 | 0.00000E+00 | −4.71879E−10 | 0.00000E+00 | 4.94531E−13 | 0.00000E+00 | | | |
| Y**4 | 3.57180E−05 | 0.00000E+00 | −2.84304E−08 | 0.00000E+00 | 5.55290E−11 | 0.00000E+00 | −1.68226E−15 | | | | |
| Y**5 | 2.95364E−07 | 0.00000E+00 | −7.79989E−11 | 0.00000E+00 | −4.64091E−13 | 0.00000E+00 | | | | | |
| Y**6 | −1.16081E−08 | 0.00000E+00 | 1.09892E−12 | 0.00000E+00 | −6.63182E−15 | | | | | | |
| Y**7 | 2.16077E−11 | 0.00000E+00 | 1.97436E−13 | 0.00000E+00 | | | | | | | |
| Y**8 | 4.65942E−13 | 0.00000E+00 | −3.24366E−15 | | | | | | | | |
| Y**9 | 8.79758E−15 | 0.00000E+00 | | | | | | | | | |
| Y**10 | −1.41536E−16 | | | | | | | | | | |
| S4 | | | | | | | | | | | |
| Y**0 | | 0.00000E+00 | 4.51232E−02 | 0.00000E+00 | −1.35857E−04 | 0.00000E+00 | 4.45171E−07 | 0.00000E+00 | −5.13990E−10 | 0.00000E+00 | −2.69573E−13 |
| Y**1 | −1.70199E+00 | 0.00000E+00 | −1.59886E−03 | 0.00000E+00 | 8.11641E−06 | 0.00000E+00 | −2.78629E−08 | 0.00000E+00 | 5.33101E−11 | 0.00000E+00 | |
| Y**2 | 2.14722E−01 | 0.00000E+00 | −3.07680E−05 | 0.00000E+00 | −2.68619E−07 | 0.00000E+00 | 1.22398E−10 | 0.00000E+00 | −7.94657E−13 | | |
| Y**3 | −1.19943E−02 | 0.00000E+00 | 5.12370E−06 | 0.00000E+00 | 8.81852E−09 | 0.00000E+00 | 3.20465E−12 | 0.00000E+00 | | | |
| Y**4 | 2.71212E−04 | 0.00000E+00 | −7.97778E−08 | 0.00000E+00 | 4.70932E−11 | 0.00000E+00 | 2.92320E−14 | | | | |
| Y**5 | 3.58557E−06 | 0.00000E+00 | −1.03906E−08 | 0.00000E+00 | −5.54750E−12 | 0.00000E+00 | | | | | |
| Y**6 | −2.32955E−07 | 0.00000E+00 | 4.02664E−10 | 0.00000E+00 | 2.47691E−14 | | | | | | |
| Y**7 | −2.26325E−10 | 0.00000E+00 | −1.86687E−12 | 0.00000E+00 | | | | | | | |
| Y**8 | 9.36027E−11 | 0.00000E+00 | −5.49138E−14 | | | | | | | | |
| Y**9 | −3.59240E−15 | 0.00000E+00 | | | | | | | | | |
| Y**10 | −1.82737E−14 | | | | | | | | | | |

Table 10 below illustrates each of corresponding values of formulae (1) to (6) in the first to third numerical examples. Note that, for formula (6), in a case where a large screen image perpendicular to the optical axis OA is projected in an oblique direction toward the screen, the image forming element is also often shifted in the Y direction from the optical axis PA as necessary. Here, cases where the shift amount of the image forming element in the Y direction is −7.182 mm and −9.018 mm will be exemplified. That is, in FIG. 1, the center position of the original image SA of the image forming element is shifted downward by 7.182 mm and 9.018 mm with respect to the optical axis OA.

TABLE 10

| Conditions | | Example 1 | Example 2 | Example 3 |
|---|---|---|---|---|
| (1) | PL2/PL1 | 0.66 | 0.61 | 0.69 |
| (2) | \|(zt2 − zr1)/(yt2 − yr1)\| | 0.16 | 0.01 | 0.03 |
| (3) | αr2 | 2.64 | 1.12 | 1.96 |
| (4) | rdx/rdy | 0.61 | 0.04 | 0.31 |
| (5) | αi2m | 23.71 | 24.65 | 24.44 |
| | PL2 | 19.16 | 18.20 | 19.92 |
| | PL1 | 28.95 | 30.04 | 28.93 |
| | \|(yt2 − yr1)\| | 11.07 | 12.40 | 11.95 |
| | \|(zt2 − zr1)\| | 1.77 | 0.06 | 0.32 |
| | ry | 71.47 | 807.62 | 87.77 |
| | rx | 43.81 | 32.51 | 27.34 |
| Image forming | H | 3249 | 3231.243 | 3221.466 |
| element shift | D | 1131 | 1131 | 1131 |
| amount −7.182 mm | V | 2022 | 2015 | 2013 |
| | SF | −1672 | −1658 | −1664 |
| | \|(SF x H)/(V × D)\| . . . (6) | 2.38 | 2.35 | 2.35 |
| | Horizontal angle of view | 109.7 | 109.2 | 109.0 |
| Image forming | H | 3247.59 | 3232.387 | 3227.906 |
| element shift | D | 1131 | 1131 | 1131 |
| amount −9.018 mm | V | 2042 | 2076 | 2051 |
| | SF | −2011 | −2027 | −2016 |
| | [(SF x H)/(V × D)\| . . . (6) | 2.83 | 2.79 | 2.81 |
| | Horizontal angle of view | 109.7 | 109.2 | 109.1 |

### Fourth Numerical Example

For the optical system of a fourth numerical example (corresponding to the fourth example), the lens data is illustrated in Table 11, the aspherical shape data of the lens is illustrated in Table 12, and the free-form surface shape data of the prism is illustrated in Table 13.

TABLE 11

| | Surface | Surface | Curvature | | Refractive | | Refraction/ | Eccentric | Y |
|---|---|---|---|---|---|---|---|---|---|
| | number | type | radius | Interval | index | Abbe number | Reflection | type | eccentricity |
| SA | S0 | Sphere | ∞ | 0.0000 | 1.0000 | 0.000 | Refraction | | |
| PA | S1 | Sphere | ∞ | 19.5590 | 1.7432 | 49.339 | Refraction | | |
| PA | S2 | Sphere | ∞ | 10.3430 | 1.0000 | 0.000 | Refraction | | |
| L1 | S3 | Sphere | 17.4146 | 8.0819 | 1.4370 | 95.099 | Refraction | | |
| L1 | S4 | Sphere | −82.8300 | 0.2000 | 1.0000 | 0.000 | Refraction | | |
| L2 | S5 | Aspherical surface | 21.3706 | 5.3174 | 1.6104 | 57.927 | Refraction | | |
| L2 | S6 | Aspherical surface | −300.0000 | 1.8268 | 1.0000 | 0.000 | Refraction | | |
| L3 | S7 | Sphere | −36.6289 | 3.0000 | 1.4875 | 70.440 | Refraction | | |
| L3 | S8 | Sphere | 1985.3044 | 3.4577 | 1.0000 | 0.000 | Refraction | | |
| L4 | S9 | Sphere | −330.7134 | 1.5000 | 1.6730 | 38.255 | Refraction | | |
| L4 | S10 | Sphere | 13.8028 | 0.2019 | 1.0000 | 0.000 | Refraction | | |
| L5 | S11 | Sphere | 14.8509 | 4.8823 | 1.4370 | 95.099 | Refraction | | |
| L5 | S12 | Sphere | −31.3215 | 2.6134 | 1.0000 | 0.000 | Refraction | | |
| ST aperture | S13 | Sphere | ∞ | 0.0000 | 1.0000 | 0.000 | Refraction | | |
| stop | | | | | | | | | |
| | S14 | Sphere | ∞ | 40.3600 | 1.0000 | 0.000 | Refraction | | |
| L6 | S15 | Sphere | 42.1735 | 6.9445 | 1.4875 | 70.440 | Refraction | | |
| L6 | S16 | Sphere | 57.1533 | 13.1271 | 1.0000 | 0.000 | Refraction | | |
| L7 | S17 | Sphere | 112.7683 | 9.2235 | 1.6477 | 33.840 | Refraction | | |
| L7 | S18 | Sphere | −274.9300 | 2.5000 | 1.0000 | 0.000 | Refraction | | |
| L8 | S19 | Sphere | 43.3824 | 11.2538 | 1.8348 | 42.721 | Refraction | | |
| L8 | S20 | Sphere | 83.7451 | 8.0171 | 1.0000 | 0.000 | Refraction | | |
| L9 | S21 | Sphere | −77.3906 | 3.1895 | 1.8467 | 23.784 | Refraction | | |
| L9 | S22 | Sphere | 1400.0000 | 13.6271 | 1.0000 | 0.000 | Refraction | | |
| L10 | S23 | Aspherical surface | 299.9995 | 5.3884 | 1.5094 | 56.474 | Refraction | | |
| L10 | S24 | Aspherical surface | 67.1412 | 12.5590 | 1.0000 | 0.000 | Refraction | | |
| T1 | S25 | XY polynomial | 119.9570 | 23.5487 | 1.5866 | 59.013 | Refraction | DAR | 6.8490 |
| | | surface | | | | | | | |
| R1 | S26 | XY polynomial | −82.3116 | −19.4565 | 1.5866 | 59.013 | Reflection | DAR | 14.5340 |
| | | surface | | | | | | | |
| R2 | S27 | XY polynomial | 104.3822 | 16.0245 | 1.5866 | 59.013 | Reflection | DAR | −1.2085 |
| | | surface | | | | | | | |
| R3 | S28 | XY polynomial | 64.5880 | −14.1727 | 1.5866 | 59.013 | Reflection | DAR | 6.2427 |
| | | surface | | | | | | | |
| T2 | S29 | XY polynomial | 71.4369 | −10.0000 | 1.0000 | 0.000 | Refraction | DAR | −5.9327 |
| | | surface | | | | | | | |
| | S30 | Sphere | ∞ | −487.3870 | 1.0000 | 0.000 | Refraction | | |
| SR | S31 | | ∞ | 0.0000 | 1.0000 | 0.000 | Refraction | | |

| | |
|---|---|
| Object height | Image height |

| Field | X | Y | X | Y |
|---|---|---|---|---|
| f1 | 0.000 | 1.458 | 0.0 | 404.7 |
| f2 | 0.000 | 4.374 | 0.0 | 1214.1 |
| f3 | 0.000 | 7.290 | 0.0 | 2023.6 |
| f4 | 2.592 | 1.458 | 719.5 | 404.7 |
| f5 | 2.592 | 4.374 | 719.5 | 1214.1 |
| f6 | 2.592 | 7.290 | 719.5 | 2023.6 |
| f7 | 5.184 | 1.458 | 1439.0 | 404.7 |
| f8 | 5.184 | 4.374 | 1439.0 | 1214.1 |
| f9 | 5.184 | 7.290 | 1439.0 | 2023.6 |

Display element size

| | |
|---|---|
| Long side | 10.368 |
| Short side | 5.832 |
| Element size | 0.468 |
| Display element shift amount | 4.374 |

Screen projection size

| | |
|---|---|
| 130 inch | 3302.0 |
| Long side | 2877.9 |
| Short side | 1618.8 |
| Imaging magnification | 277.6 |

Aperture diameter

| | |
|---|---|
| Aperture stop surface | 7.664 |

TABLE 12
Aspherical coefficient

| | S7 | S8 | S25 | S26 |
|---|---|---|---|---|
| Conic constant (K) | 0.000 | 0.000 | 0.000 | 0.000 |
| Fourth order coefficient (A) | −3.69491E−05 | −3.19427E−06 | −8.24849E−06 | −2.79318E−05 |
| Sixth order coefficient (B) | −3.09552E−07 | −3.90168E−07 | −2.00505E−08 | 3.43358E−09 |
| Eighth order coefficient (C) | 7.61079E−10 | 3.04265E−09 | 6.13588E−11 | 2.30139E−11 |
| Tenth order coefficient (D) | −2.20056E−11 | −5.04458E−11 | −3.12645E−14 | 2.08090E−14 |
| Twelfth order coefficient (E) | 7.99170E−14 | 3.54955E−13 | −5.88460E−18 | −2.94718E−17 |
| Fourteenth order coefficient (F) | −4.70794E−17 | −9.27685E−16 | 0.000 | 0.000 |

TABLE 13
XY polynomial surface coefficient
S27 Conic constant (K) 0.00000

| | X**0 | X**1 | X**2 | X**3 | X**4 | X**5 |
|---|---|---|---|---|---|---|
| Y**0 | | 0.00000E+00 | −5.61519E−02 | 0.00000E+00 | 1.76876E−04 | 0.00000E+00 |
| Y**1 | −2.35901E+00 | 0.00000E+00 | −4.69326E−03 | 0.00000E+00 | 6.33358E−06 | 0.00000E+00 |
| Y**2 | −3.28055E−01 | 0.00000E+00 | −2.54491E−04 | 0.00000E+00 | −3.29903E−07 | 0.00000E+00 |
| Y**3 | −2.05072E−02 | 0.00000E+00 | −1.00922E−05 | 0.00000E+00 | −2.76236E−08 | 0.00000E+00 |
| Y**4 | −6.20348E−04 | 0.00000E+00 | −2.55742E−07 | 0.00000E+00 | −7.59212E−10 | 0.00000E+00 |
| Y**5 | −5.77353E−06 | 0.00000E+00 | −1.15641E−08 | 0.00000E+00 | −1.01553E−12 | 0.00000E+00 |
| Y**6 | −1.11555E−07 | 0.00000E+00 | −4.42053E−10 | 0.00000E+00 | 2.07087E−13 | |
| Y**7 | −1.72836E−08 | 0.00000E+00 | −4.22776E−12 | 0.00000E+00 | | |
| Y**8 | −5.26448E−10 | 0.00000E+00 | 5.71965E−14 | | | |
| Y**9 | −2.64891E−12 | 0.00000E+00 | | | | |
| Y**10 | 5.17104E−14 | | | | | |

S27 Conic constant (K) 0.00000

| | X**6 | X**7 | X**8 | X**9 | X**10 |
|---|---|---|---|---|---|
| Y**0 | −6.09402E−07 | 0.00000E+00 | 9.56267E−10 | 0.00000E+00 | −5.93890E−13 |
| Y**1 | −3.50366E−08 | 0.00000E+00 | 4.16630E−11 | 0.00000E+00 | |
| Y**2 | −6.15183E−10 | 0.00000E+00 | 5.03903E−13 | | |
| Y**3 | −5.23913E−12 | 0.00000E+00 | | | |
| Y**4 | 7.34918E−14 | | | | |
| Y**5 | | | | | |
| Y**6 | | | | | |
| Y**7 | | | | | |
| Y**8 | | | | | |
| Y**9 | | | | | |
| Y**10 | | | | | |

S28 Conic constant (K) −4.62132

| | X**0 | X**1 | X**2 | X**3 | X**4 | X**5 |
|---|---|---|---|---|---|---|
| Y**0 | | 0.00000E+00 | −1.09961E−02 | 0.00000E+00 | 1.40590E−05 | 0.00000E+00 |
| Y**1 | −1.57464E+00 | 0.00000E+00 | 1.99852E−04 | 0.00000E+00 | 6.92212E−07 | 0.00000E+00 |
| Y**2 | −8.93976E−02 | 0.00000E+00 | −1.17157E−05 | 0.00000E+00 | 3.74606E−08 | 0.00000E+00 |
| Y**3 | −2.75152E−03 | 0.00000E+00 | −2.32652E−07 | 0.00000E+00 | −1.69067E−09 | 0.00000E+00 |
| Y**4 | −4.86208E−05 | 0.00000E+00 | 3.31411E−08 | 0.00000E+00 | −1.36696E−10 | 0.00000E+00 |
| Y**5 | −7.94274E−08 | 0.00000E+00 | −4.21189E−11 | 0.00000E+00 | −4.34111E−13 | 0.00000E+00 |
| Y**6 | 1.19651E−08 | 0.00000E+00 | −3.63053E−11 | 0.00000E+00 | 5.45083E−14 | |
| Y**7 | −1.33316E−10 | 0.00000E+00 | 1.52120E−13 | 0.00000E+00 | | |
| Y**8 | −1.81100E−11 | 0.00000E+00 | 1.84646E−14 | | | |
| Y**9 | −3.67633E−13 | 0.00000E+00 | | | | |
| Y**10 | −1.78234E−15 | | | | | |

S28 Conic constant (K) −4.62132

| | X**6 | X**7 | X**8 | X**9 | X**10 |
|---|---|---|---|---|---|
| Y**0 | 1.48168E−08 | 0.00000E+00 | −2.13148E−11 | 0.00000E+00 | −7.45344E−14 |
| Y**1 | 3.08951E−09 | 0.00000E+00 | −9.72928E−12 | 0.00000E+00 | |
| Y**2 | −2.22629E−12 | 0.00000E+00 | −2.13223E−13 | | |
| Y**3 | −2.42241E−12 | 0.00000E+00 | | | |
| Y**4 | 2.44423E−14 | | | | |
| Y**5 | | | | | |
| Y**6 | | | | | |
| Y**7 | | | | | |
| Y**8 | | | | | |
| Y**9 | | | | | |
| Y**10 | | | | | |

S29 Conic constant (K) 0.00000

| | X**0 | X**1 | X**2 | X**3 | X**4 | X**5 |
|---|---|---|---|---|---|---|
| Y**0 | | 0.00000E+00 | 3.01157E−03 | 0.00000E+00 | −5.90666E−06 | 0.00000E+00 |
| Y**1 | 4.40056E−02 | 0.00000E+00 | −2.02611E−04 | 0.00000E+00 | 4.33608E−07 | 0.00000E+00 |
| Y**2 | 3.02068E−03 | 0.00000E+00 | 7.38903E−06 | 0.00000E+00 | −1.45141E−08 | 0.00000E+00 |
| Y**3 | −8.78875E−05 | 0.00000E+00 | −3.74253E−07 | 0.00000E+00 | 0.00000E+00 | 0.00000E+00 |
| Y**4 | −1.12761E−06 | 0.00000E+00 | 8.25229E−09 | 0.00000E+00 | 0.00000E+00 | 0.00000E+00 |
| Y**5 | −1.49813E−07 | 0.00000E+00 | 0.00000E+00 | 0.00000E+00 | 0.00000E+00 | 0.00000E+00 |
| Y**6 | 5.74831E−08 | 0.00000E+00 | 0.00000E+00 | 0.00000E+00 | 0.00000E+00 | |
| Y**7 | −6.93221E−09 | 0.00000E+00 | 0.00000E+00 | 0.00000E+00 | | |
| Y**8 | 4.26969E−10 | 0.00000E+00 | 0.00000E+00 | | | |
| Y**9 | −1.35821E−11 | 0.00000E+00 | | | | |
| Y**10 | 1.76539E−13 | | | | | |

S29 Conic constant (K) 0.00000

| | X**6 | X**7 | X**8 | X**9 | X**10 |
|---|---|---|---|---|---|
| Y**0 | 2.45955E−09 | 0.00000E+00 | 0.00000E+00 | 0.00000E+00 | 0.00000E+00 |
| Y**1 | 0.00000E+00 | 0.00000E+00 | 0.00000E+00 | 0.00000E+00 | |
| Y**2 | 0.00000E+00 | 0.00000E+00 | 0.00000E+00 | | |
| Y**3 | 0.00000E+00 | 0.00000E+00 | | | |
| Y**4 | 0.00000E+00 | | | | |
| Y**5 | | | | | |
| Y**6 | | | | | |
| Y**7 | | | | | |
| Y**8 | | | | | |
| Y**9 | | | | | |
| Y**10 | | | | | |

S30 Conic constant (K) 0.00000

| | X**0 | X**1 | X**2 | X**3 | X**4 | X**5 |
|---|---|---|---|---|---|---|
| Y**0 | | 0.00000E+00 | 4.75652E−05 | 0.00000E+00 | −3.57706E−06 | 0.00000E+00 |
| Y**1 | 1.81996E−01 | 0.00000E+00 | −1.67078E−04 | 0.00000E+00 | 2.46422E−07 | 0.00000E+00 |
| Y**2 | −1.30191E−03 | 0.00000E+00 | −2.92606E−06 | 0.00000E+00 | −4.71080E−09 | 0.00000E+00 |
| Y**3 | −1.04482E−04 | 0.00000E+00 | 1.31593E−07 | 0.00000E+00 | −1.02040E−10 | 0.00000E+00 |
| Y**4 | −6.72609E−07 | 0.00000E+00 | −1.40248E−10 | 0.00000E+00 | 1.48076E−12 | 0.00000E+00 |
| Y**5 | 4.92017E−09 | 0.00000E+00 | −1.29591E−11 | 0.00000E+00 | 8.25866E−14 | 0.00000E+00 |
| Y**6 | −1.17155E−10 | 0.00000E+00 | −2.25577E−12 | 0.00000E+00 | −1.25696E−15 | |
| Y**7 | −3.84674E−13 | 0.00000E+00 | 1.33595E−15 | 0.00000E+00 | | |
| Y**8 | 4.05827E−13 | 0.00000E+00 | 1.52273E−15 | | | |
| Y**9 | 5.83713E−15 | 0.00000E+00 | | | | |
| Y**10 | −5.90524E−16 | | | | | |

S30 Conic constant (K) 0.00000

| | X**6 | X**7 | X**8 | X**9 | X**10 |
|---|---|---|---|---|---|
| Y**0 | 1.51815E−09 | 0.00000E+00 | 1.38558E−13 | 0.00000E+00 | −1.00205E−15 |
| Y**1 | −3.60848E−10 | 0.00000E+00 | 2.42482E−13 | 0.00000E+00 | |
| Y**2 | 1.19106E−11 | 0.00000E+00 | −7.71198E−15 | | |
| Y**3 | −7.78659E−14 | 0.00000E+00 | | | |
| Y**4 | 2.29055E−16 | | | | |
| Y**5 | | | | | |
| Y**6 | | | | | |
| Y**7 | | | | | |
| Y**8 | | | | | |
| Y**9 | | | | | |
| Y**10 | | | | | |

S31 Conic constant (K) 0.00000

| | X**0 | X**1 | X**2 | X**3 | X**4 | X**5 |
|---|---|---|---|---|---|---|
| Y**0 | | 0.00000E+00 | −1.02545E−02 | 0.00000E+00 | 1.60350E−05 | 0.00000E+00 |
| Y**1 | −1.51756E+00 | 0.00000E+00 | 2.20230E−03 | 0.00000E+00 | −1.44496E−06 | 0.00000E+00 |
| Y**2 | 8.34813E−02 | 0.00000E+00 | −8.87440E−05 | 0.00000E+00 | 3.07941E−08 | 0.00000E+00 |
| Y**3 | −1.30230E−03 | 0.00000E+00 | 6.33976E−07 | 0.00000E+00 | 1.87270E−10 | 0.00000E+00 |
| Y**4 | −2.31274E−05 | 0.00000E+00 | 2.14820E−08 | 0.00000E+00 | −5.28048E−13 | 0.00000E+00 |
| Y**5 | 7.41914E−07 | 0.00000E+00 | 3.09356E−10 | 0.00000E+00 | −2.17499E−13 | 0.00000E+00 |
| Y**6 | 8.43402E−09 | 0.00000E+00 | −3.50060E−11 | 0.00000E+00 | 1.72026E−15 | |
| Y**7 | −1.44370E−10 | 0.00000E+00 | 8.25057E−13 | 0.00000E+00 | | |
| Y**8 | −1.59469E−11 | 0.00000E+00 | −7.20332E−15 | | | |
| Y**9 | 4.80188E−13 | 0.00000E+00 | | | | |
| Y**10 | −3.98171E−15 | | | | | |

S31 Conic constant (K) 0.00000

| | X**6 | X**7 | X**8 | X**9 | X**10 |
|---|---|---|---|---|---|
| Y**0 | −8.63844E−09 | 0.00000E+00 | 4.63630E−12 | 0.00000E+00 | −9.67866E−16 |
| Y**1 | 1.74921E−10 | 0.00000E+00 | 3.53461E−14 | 0.00000E+00 | |
| Y**2 | 1.25967E−11 | 0.00000E+00 | −4.72363E−15 | | |
| Y**3 | −2.66780E−13 | 0.00000E+00 | | | |
| Y**4 | −1.46172E−16 | | | | |
| Y**5 | | | | | |
| Y**6 | | | | | |
| Y**7 | | | | | |
| Y**8 | | | | | |
| Y**9 | | | | | |
| Y**10 | | | | | |

### Fifth Numerical Example

For the optical system of a fifth numerical example (corresponding to the fifth example), the lens data is illustrated in Table 14, the aspherical shape data of the lens is illustrated in Table 15, and the free-form surface shape data of the prism is illustrated in Table 16.

TABLE 14

| | Surface | Surface | Curvature | | Refractive | Abbe | Refraction/ | Eccentric | Y |
|---|---|---|---|---|---|---|---|---|---|
| | number | type | radius | Interval | index | number | Reflection | type | eccentricity |
| SA | S0 | Sphere | ∞ | 0.0000 | 1.0000 | 0.000 | Refraction | | |
| PA | S1 | Sphere | ∞ | 19.5590 | 1.7432 | 49.339 | Refraction | | |
| PA | S2 | Sphere | ∞ | 10.3430 | 1.0000 | 0.000 | Refraction | | |
| L1 | S3 | Sphere | 17.2802 | 7.7759 | 1.4370 | 95.099 | Refraction | | |
| L1 | S4 | Sphere | −130.8658 | 0.2000 | 1.0000 | 0.000 | Refraction | | |
| L2 | S5 | Aspherical | 19.6818 | 5.5354 | 1.6104 | 57.927 | Refraction | | |
| | | surface | | | | | | | |
| L2 | S6 | Aspherical | −300.0000 | 1.7009 | 1.0000 | 0.000 | Refraction | | |
| | | surface | | | | | | | |
| L3 | S7 | Sphere | −41.3334 | 3.0000 | 1.4875 | 70.440 | Refraction | | |
| L3 | S8 | Sphere | 213.2147 | 2.8995 | 1.0000 | 0.000 | Refraction | | |
| L4 | S9 | Sphere | 2748.4136 | 1.5000 | 1.6730 | 38.255 | Refraction | | |
| L4 | S10 | Sphere | 12.5359 | 0.2000 | 1.0000 | 0.000 | Refraction | | |
| L5 | S11 | Sphere | 13.3221 | 5.0493 | 1.4370 | 95.099 | Refraction | | |
| L5 | S12 | Sphere | −33.7686 | 3.0285 | 1.0000 | 0.000 | Refraction | | |
| ST | S13 | Sphere | ∞ | 0.0000 | 1.0000 | 0.000 | Refraction | | |
| Aperture | | | | | | | | | |
| stop | | | | | | | | | |
| | S14 | Sphere | ∞ | 42.0000 | 1.0000 | 0.000 | Refraction | | |
| L6 | S15 | Sphere | 43.2569 | 7.0586 | 1.4875 | 70.440 | Refraction | | |
| L6 | S16 | Sphere | 58.2183 | 9.8404 | 1.0000 | 0.000 | Refraction | | |
| L7 | S17 | Sphere | 121.2885 | 9.5841 | 1.6477 | 33.840 | Refraction | | |
| L7 | S18 | Sphere | −189.3181 | 3.8660 | 1.0000 | 0.000 | Refraction | | |
| L8 | S19 | Sphere | 41.2105 | 11.2219 | 1.8348 | 42.721 | Refraction | | |
| L8 | S20 | Sphere | 72.0186 | 8.4831 | 1.0000 | 0.000 | Refraction | | |
| L9 | S21 | Sphere | −76.0786 | 5.5598 | 1.8467 | 23.784 | Refraction | | |
| L9 | S22 | Sphere | 427.9671 | 11.4571 | 1.0000 | 0.000 | Refraction | | |
| L10 | S23 | Aspherical | 299.9803 | 6.0000 | 1.5094 | 56.474 | Refraction | | |
| | | surface | | | | | | | |
| L10 | S24 | Aspherical | 67.0935 | 13.8756 | 1.0000 | 0.000 | Refraction | | |
| | | surface | | | | | | | |
| T1 | S25 | XY polynomial | 45.0852 | 21.0519 | 1.5866 | 59.013 | Refraction | DAR | 5.8114 |
| | | surface | | | | | | | |
| R1 | S26 | XY polynomial | −304.8108 | −19.0000 | 1.5866 | 59.013 | Reflection | DAR | 14.3506 |
| | | surface | | | | | | | |
| R2 | S27 | XY polynomial | 90.4459 | 20.9589 | 1.5866 | 59.013 | Reflection | DAR | −2.0457 |
| | | surface | | | | | | | |
| R3 | S28 | XY polynomial | 47.0643 | −17.5738 | 1.5866 | 59.013 | Reflection | DAR | 10.1425 |
| | | surface | | | | | | | |
| T2 | S29 | XY polynomial | 49.9583 | −10.0000 | 1.0000 | 0.000 | Refraction | DAR | 1.0520 |
| | | surface | | | | | | | |
| | S30 | Sphere | ∞ | −427.5463 | 1.0000 | 0.000 | Refraction | | |
| SR | S31 | | ∞ | 0.0000 | 1.0000 | 0.000 | Refraction | | |

| | |
|---|---|
| Object height | Image height |

| Field | X | Y | X | Y |
|---|---|---|---|---|
| f1 | 0.000 | 1.458 | 0.0 | 404.7 |
| f2 | 0.000 | 4.374 | 0.0 | 1214.1 |
| f3 | 0.000 | 7.290 | 0.0 | 2023.6 |
| f4 | 2.592 | 1.458 | 719.5 | 404.7 |
| f5 | 2.592 | 4.374 | 719.5 | 121.41 |
| f6 | 2.592 | 7.290 | 719.5 | 2023.6 |
| f7 | 5.184 | 1.458 | 1439.0 | 404.7 |
| f8 | 5.184 | 4.374 | 1439.0 | 1214.1 |
| f9 | 5.184 | 7.290 | 1439.0 | 2023.6 |

Display element size

| | |
|---|---|
| Long side | 10.368 |
| Short side | 5.832 |
| Element size | 0.468 |
| Display element shift amount | 4.374 |

Screen projection size

| | |
|---|---|
| 130 inch | 3302.0 |
| Long side | 2877.9 |
| Short side | 1618.8 |
| Imaging magnification | 277.6 |

Aperture diameter

| | |
|---|---|
| Aperture stop surface | 7.566 |

TABLE 15
Aspherical coefficient

| | S7 | S8 | S25 | S26 |
|---|---|---|---|---|
| Conic constant (K) | 0.000 | 0.000 | 0.000 | 0.000 |
| Fourth order coefficient (A) | −3.77248E−05 | 8.38691E−07 | 1.84088E−06 | −1.48766E−05 |
| Sixth order coefficient (B) | −3.02458E−07 | −4.53062E−07 | −2.21006E−08 | −2.75451E−09 |
| Eighth order coefficient (C) | 1.06489E−10 | 3.39935E−09 | 1.70148E−11 | −3.34785E−11 |
| Tenth order coefficient (D) | −1.41047E−11 | −5.79001E−11 | 4.36710E−14 | 1.25121E−13 |
| Twelfth order coefficient (E) | −2.13048E−15 | 3.94273E−13 | −4.80117E−17 | −9.09816E−17 |
| Fourteenth order coefficient (F) | 1.82685E−16 | −9.72773E−16 | 0.000 | 0.000 |

TABLE 16
XY polynomial surface coefficient
S27 Conic constant (K) 0.00000

| | X**0 | X**1 | X**2 | X**3 | X**4 | X**5 |
|---|---|---|---|---|---|---|
| Y**0 | | 0.00000E+00 | −7.53843E−02 | 0.00000E+00 | 3.20941E−04 | 0.00000E+00 |
| Y**1 | −1.98653E+00 | 0.00000E+00 | −7.43538E−03 | 0.00000E+00 | 2.57736E−05 | 0.00000E+00 |
| Y**2 | −3.19139E−01 | 0.00000E+00 | −4.16771E−04 | 0.00000E+00 | 3.50386E−07 | 0.00000E+00 |
| Y**3 | −2.16267E−02 | 0.00000E+00 | −1.18538E−05 | 0.00000E+00 | −3.11359E−08 | 0.00000E+00 |
| Y**4 | −7.87527E−04 | 0.00000E+00 | −1.06664E−07 | 0.00000E+00 | −1.35797E−09 | 0.00000E+00 |
| Y**5 | −1.39945E−05 | 0.00000E+00 | −1.28663E−08 | 0.00000E+00 | −5.11437E−12 | 0.00000E+00 |
| Y**6 | −3.17268E−07 | 0.00000E+00 | −7.61552E−10 | 0.00000E+00 | 4.71376E−13 | |
| Y**7 | 2.21326E−08 | 0.00000E+00 | −7.03143E−12 | 0.00000E+00 | | |
| Y**8 | −6.57070E−10 | 0.00000E+00 | 1.17271E−13 | | | |
| Y**9 | −3.90473E−12 | 0.00000E+00 | | | | |
| Y**10 | 6.08895E−14 | | | | | |

S27 Conic constant (K) 0.00000

| | X**6 | X**7 | X**8 | X**9 | X**10 |
|---|---|---|---|---|---|
| Y**0 | −1.44848E−06 | 0.00000E+00 | 2.25234E−09 | 0.00000E+00 | −4.32970E−13 |
| Y**1 | −1.52173E−07 | 0.00000E+00 | 2.31187E−10 | 0.00000E+00 | |
| Y**2 | −4.49785E−09 | 0.00000E+00 | 6.15566E−12 | | |
| Y**3 | −1.44016E−11 | 0.00000E+00 | | | |
| Y**4 | 4.46287E−13 | | | | |
| Y**5 | | | | | |
| Y**6 | | | | | |
| Y**7 | | | | | |
| Y**8 | | | | | |
| Y**9 | | | | | |
| Y**10 | | | | | |

S28 Conic constant (K) −3.25682

| | X**0 | X**1 | X**2 | X**3 | X**4 | X**5 |
|---|---|---|---|---|---|---|
| Y**0 | | 0.00000E+00 | 1.02937E−03 | 0.00000E+00 | 4.35320E−05 | 0.00000E+00 |
| Y**1 | −1.53058E+00 | 0.00000E+00 | 2.23019E−03 | 0.00000E+00 | 4.09276E−06 | 0.00000E+00 |
| Y**2 | 8.92727E−02 | 0.00000E+00 | 6.17991E−05 | 0.00000E+00 | 1.70008E−07 | 0.00000E+00 |
| Y**3 | 2.79720E−03 | 0.00000E+00 | −3.16279E−07 | 0.00000E+00 | −1.77960E−09 | 0.00000E+00 |
| Y**4 | −6.01567E−05 | 0.00000E+00 | −1.05492E−08 | 0.00000E+00 | −1.98172E−10 | 0.00000E+00 |
| Y**5 | −1.45468E−07 | 0.00000E+00 | −5.66131E−11 | 0.00000E+00 | −3.30507E−13 | 0.00000E+00 |
| Y**6 | 2.13995E−08 | 0.00000E+00 | −1.90229E−11 | 0.00000E+00 | 7.07096E−14 | |
| Y**7 | −1.89049E−10 | 0.00000E+00 | 2.51839E−14 | 0.00000E+00 | | |
| Y**8 | −2.66616E−11 | 0.00000E+00 | 1.37386E−14 | | | |
| Y**9 | −4.20396E−13 | 0.00000E+00 | | | | |
| Y**10 | −7.36021E−16 | | | | | |

S28 Conic constant (K) −3.25682

| | X**6 | X**7 | X**8 | X**9 | X**10 |
|---|---|---|---|---|---|
| Y**0 | −1.45116E−07 | 0.00000E+00 | 1.72397E−10 | 0.00000E+00 | −2.53245E−13 |
| Y**1 | −1.25465E−08 | 0.00000E+00 | −3.51151E−12 | 0.00000E+00 | |
| Y**2 | −5.21203E−10 | 0.00000E+00 | −7.94979E−14 | | |
| Y**3 | −3.04650E−12 | 0.00000E+00 | | | |
| Y**4 | 1.70252E−13 | | | | |
| Y**5 | | | | | |
| Y**6 | | | | | |
| Y**7 | | | | | |
| Y**8 | | | | | |
| Y**9 | | | | | |
| Y**10 | | | | | |

S29 Conic constant (K) 0.00000

| | X**0 | X**1 | X**2 | X**3 | X**4 | X**5 |
|---|---|---|---|---|---|---|
| Y**0 | | 0.00000E+00 | 2.67616E−03 | 0.00000E+00 | −4.98211E−06 | 0.00000E+00 |
| Y**1 | 7.86129E−02 | 0.00000E+00 | −2.26357E−04 | 0.00000E+00 | 3.68899E−07 | 0.00000E+00 |
| Y**2 | 2.66920E−03 | 0.00000E+00 | 8.09075E−06 | 0.00000E+00 | −1.01875E−08 | 0.00000E+00 |
| Y**3 | −1.22665E−04 | 0.00000E+00 | −3.65926E−07 | 0.00000E+00 | 0.00000E+00 | 0.00000E+00 |
| Y**4 | 1.13908E−06 | 0.00000E+00 | 6.36965E−09 | 0.00000E+00 | 0.00000E+00 | 0.00000E+00 |
| Y**5 | −2.76436E−07 | 0.00000E+00 | 0.00000E+00 | 0.00000E+00 | 0.00000E+00 | 0.00000E+00 |
| Y**6 | 6.38980E−08 | 0.00000E+00 | 0.00000E+00 | 0.00000E+00 | 0.00000E+00 | |
| Y**7 | −7.07264E−09 | 0.00000E+00 | 0.00000E+00 | 0.00000E+00 | | |
| Y**8 | 4.17290E−10 | 0.00000E+00 | 0.00000E+00 | | | |
| Y**9 | −1.28223E−11 | 0.00000E+00 | | | | |
| Y**10 | 1.62205E−13 | | | | | |

S29 Conic constant (K) 0.00000

| | X**6 | X**7 | X**8 | X**9 | X**10 |
|---|---|---|---|---|---|
| Y**0 | 2.31062E−10 | 0.00000E+00 | 0.00000E+00 | 0.00000E+00 | 0.00000E+00 |
| Y**1 | 0.00000E+00 | 0.00000E+00 | 0.00000E+00 | 0.00000E+00 | |
| Y**2 | 0.00000E+00 | 0.00000E+00 | 0.00000E+00 | | |
| Y**3 | 0.00000E+00 | 0.00000E+00 | | | |
| Y**4 | 0.00000E+00 | | | | |
| Y**5 | | | | | |
| Y**6 | | | | | |
| Y**7 | | | | | |
| Y**8 | | | | | |
| Y**9 | | | | | |
| Y**10 | | | | | |

S30 Conic constant (K) 0.00000

| | X**0 | X**1 | X**2 | X**3 | X**4 | X**5 |
|---|---|---|---|---|---|---|
| Y**0 | | 0.00000E+00 | −2.89124E−03 | 0.00000E+00 | −5.09489E−06 | 0.00000E+00 |
| Y**1 | 3.01797E−01 | 0.00000E+00 | −1.95238E−04 | 0.00000E+00 | 2.65831E−07 | 0.00000E+00 |
| Y**2 | −5.74755E−03 | 0.00000E+00 | −3.97637E−06 | 0.00000E+00 | −3.99394E−09 | 0.00000E+00 |
| Y**3 | −1.78514E−04 | 0.00000E+00 | 4.02795E−07 | 0.00000E+00 | −5.46000E−10 | 0.00000E+00 |
| Y**4 | 3.60204E−06 | 0.00000E+00 | −2.94529E−08 | 0.00000E+00 | 3.63676E−11 | 0.00000E+00 |
| Y**5 | −9.42622E−08 | 0.00000E+00 | 1.24652E−09 | 0.00000E+00 | −1.41669E−12 | 0.00000E+00 |
| Y**6 | −2.60323E−09 | 0.00000E+00 | −2.68058E−11 | 0.00000E+00 | 2.55868E−14 | |
| Y**7 | −4.34997E−11 | 0.00000E+00 | 4.85803E−14 | 0.00000E+00 | | |
| Y**8 | 2.45551E−11 | 0.00000E+00 | 3.90091E−15 | | | |
| Y**9 | −1.21121E−12 | 0.00000E+00 | | | | |
| Y**10 | 1.85808E−14 | | | | | |

S30 Conic constant (K) 0.00000

| | X**6 | X**7 | X**8 | X**9 | X**10 |
|---|---|---|---|---|---|
| Y**0 | 4.00699E−09 | 0.00000E+00 | −2.71142E−12 | 0.00000E+00 | 1.70893E−16 |
| Y**1 | −4.39079E−10 | 0.00000E+00 | 2.97713E−13 | 0.00000E+00 | |
| Y**2 | 1.18900E−11 | 0.00000E+00 | −1.08120E−14 | | |
| Y**3 | 2.43834E−13 | 0.00000E+00 | | | |
| Y**4 | −8.99823E−15 | | | | |
| Y**5 | | | | | |
| Y**6 | | | | | |
| Y**7 | | | | | |
| Y**8 | | | | | |
| Y**9 | | | | | |
| Y**10 | | | | | |

S31 Conic constant (K) 0.00000

| | X**0 | X**1 | X**2 | X**3 | X**4 | X**5 |
|---|---|---|---|---|---|---|
| Y**0 | | 0.00000E+00 | −1.62689E−02 | 0.00000E+00 | 2.57193E−05 | 0.00000E+00 |
| Y**1 | −1.24806E+00 | 0.00000E+00 | 2.46483E−03 | 0.00000E+00 | −1.67458E−06 | 0.00000E+00 |
| Y**2 | 7.66842E−02 | 0.00000E+00 | −9.38867E−05 | 0.00000E+00 | 9.50075E−09 | 0.00000E+00 |
| Y**3 | −9.52056E−04 | 0.00000E+00 | 5.91494E−07 | 0.00000E+00 | 3.19750E−10 | 0.00000E+00 |
| Y**4 | −3.40277E−05 | 0.00000E+00 | 1.78750E−08 | 0.00000E+00 | 2.91721E−11 | 0.00000E+00 |
| Y**5 | 6.15133E−07 | 0.00000E+00 | 3.96769E−10 | 0.00000E+00 | −2.15378E−13 | 0.00000E+00 |
| Y**6 | 1.50977E−08 | 0.00000E+00 | −2.62817E−11 | 0.00000E+00 | −1.34436E−14 | |
| Y**7 | −7.05977E−11 | 0.00000E+00 | 7.74715E−13 | 0.00000E+00 | | |
| Y**8 | −1.69538E−11 | 0.00000E+00 | −1.11688E−14 | | | |
| Y**9 | 4.53919E−13 | 0.00000E+00 | | | | |
| Y**10 | −4.19152E−15 | | | | | |

S31 Conic constant (K) 0.00000

| | X**6 | X**7 | X**8 | X**9 | X**10 |
|---|---|---|---|---|---|
| Y**0 | −2.44840E−08 | 0.00000E+00 | 1.28120E−11 | 0.00000E+00 | −1.99492E−15 |
| Y**1 | 4.79531E−10 | 0.00000E+00 | −1.64323E−13 | 0.00000E+00 | |
| Y**2 | 4.08110E−11 | 0.00000E+00 | −7.90135E−15 | | |
| Y**3 | −7.44918E−13 | 0.00000E+00 | | | |
| Y**4 | −9.78353E−15 | | | | |
| Y**5 | | | | | |
| Y**6 | | | | | |
| Y**7 | | | | | |
| Y**8 | | | | | |
| Y**9 | | | | | |
| Y**10 | | | | | |

### Second Embodiment

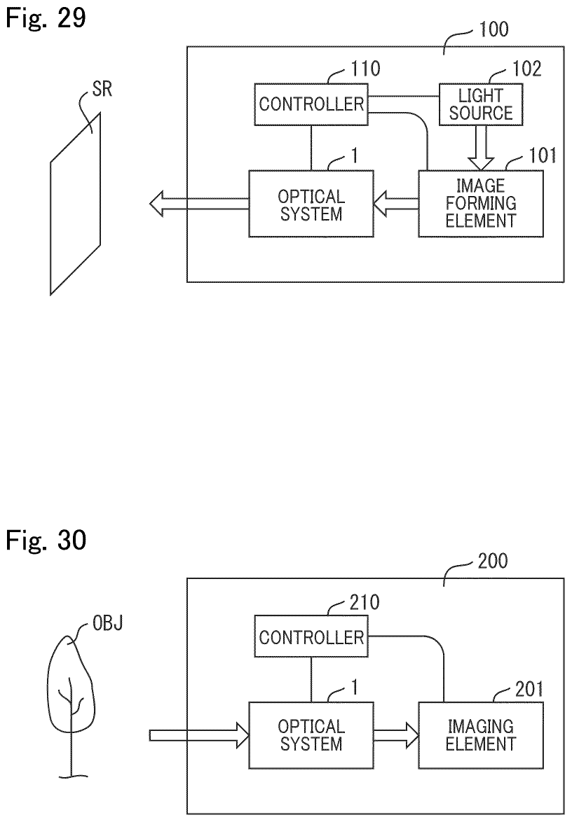

Hereinafter, a second embodiment of the present disclosure will be described with reference to FIG. 29. FIG. 29 is a block diagram illustrating an example of an image projection apparatus according to the present disclosure. The image projection apparatus 100 includes the optical system 1 disclosed in the first embodiment, an image forming element 101, a light source 102, a controller 110, and the like. The image forming element 101 includes a liquid crystal, a DMD, and the like, and generates an image to be projected onto the screen SR via the optical system 1. The light source 102 includes a light emitting diode (LED), a laser, and the like, and supplies light to the image forming element 101. The controller 110 includes a CPU, an MPU, and the like, and controls the entire device and each component. The optical system 1 may be configured as an interchangeable lens detachably attachable to the image projection apparatus 100, or may be configured as a built-in lens integrated with the image projection apparatus 100.

In the image projection apparatus 100 described above, the optical system 1 according to the first embodiment enables projection of a short focal and a large screen with a small device.

### Third Embodiment

Hereinafter, a third embodiment of the present disclosure will be described with reference to FIG. 30. FIG. 30 is a block diagram illustrating an example of an imaging apparatus according to the present disclosure. An imaging apparatus 200 includes the optical system 1 disclosed in the first embodiment, an imaging element 201, a controller 210, and the like. The imaging element 201 includes a charge coupled device (CCD) image sensor, a CMOS image sensor, and the like, and receives an optical image of an object OBJ formed by the optical system 1 and converts the optical image into an electrical image signal. The controller 110 includes a CPU, an MPU, and the like, and controls the entire apparatus and each component. The optical system 1 may be configured as an interchangeable lens detachably attachable to the imaging apparatus 200, or may be configured as a built-in lens integrated with the imaging apparatus 200.

In the imaging apparatus 200 described above, the optical system 1 according to the first embodiment enables imaging of a short focal and a large screen with a small device.

As described above, the embodiments have been described as the disclosure of the technique in the present disclosure. For this purpose, the accompanying drawings and the detailed description have been provided.

Therefore, the components described in the accompanying drawings and the detailed description may include not only components essential for solving the problem but also components that are not essential for solving the problem in order to exemplify the above technique. Therefore, it should not be immediately recognized that these non-essential components are essential on the basis of the fact that these non-essential components are described in the accompanying drawings and the detailed description.

In addition, since the above-described embodiments are intended to exemplify the technique in the present disclosure, various changes, replacements, additions, omissions, and the like can be made within the scope of the claims and equivalents thereof.

What is claimed is:

1. An optical system having a reduction conjugate point on a reduction side and a magnification conjugate point on a magnification side, and having an intermediate imaging position conjugate with each of the reduction conjugate point and the magnification conjugate point inside, the optical system comprising:
a first sub-optical system including a plurality of lenses arranged along an optical axis in a Z direction, and an aperture stop between two lenses among the plurality of lenses; and
a second sub-optical system disposed closer to the magnification side than the first sub-optical system and including a prism having a plurality of optical surfaces, wherein
the prism includes: as the plurality of optical surfaces,
a first transmission surface located on the reduction side;
a second transmission surface located on the magnification side; and
a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface,
a light flux travels in a YZ surface including the Z direction and the Y direction inside the prism,
the intermediate imaging position of a first light flux closest to the optical axis is disposed between the first transmission surface and the first reflection surface,
the second transmission surface has a shape with a convex surface facing the magnification side, and a reflection surface located on a most magnification side in the reflection surface group has a convex shape with respect to the inside of the prism,
the first reflection surface has stronger positive power than the second reflection surface, and
on the YZ surface with respect to an effective region of the plurality of optical surfaces,
a distance FL2 is smaller than a distance FL1 in the distance FL1 between a point of the first reflection surface farthest from a perpendicular line of the optical axis passing through a surface vertex of an optical surface on a most magnification side of the first sub-optical system and the perpendicular line and the distance FL2 between a point of the second transmission surface farthest from the perpendicular line and the perpendicular line.

2. The optical system according to claim 1, wherein
on the YZ surface, in a distance PL1 parallel to the Z direction between a point of the first transmission surface closest to the perpendicular line and a point of the first reflection surface farthest from the perpendicular line, and in a distance PL2 parallel to the Z direction between a point of the second reflection surface closest to the perpendicular line and a point of the second transmission surface farthest from the perpendicular line, the distance PL2 is smaller than the distance PL1.

3. The optical system according to claim 1, wherein in a case where a YZ coordinate (yt1, zt1) of a first point through which a principal ray of the first light flux passes on the first transmission surface is compared with a YZ coordinate (yr2, zr2) of a second point from which the principal ray of the first light flux reflects on the second reflection surface, a Z coordinate interval |zr2−zt1| is smaller than a Y coordinate interval |yr2−yt1|.

4. The optical system according to claim 2, satisfying the following formulae (1) and (2):
$$0.5 < PL 2 / PL 1 < 0.8 \qquad ( 1 )$$
$$\vert ( zr 2 - zt 1 ) / ( yr 2 - yt 1 ) \vert < 1. . \qquad ( 2 )$$

5. The optical system according to claim 1, satisfying the following formula (3):
$$0.5 < α r 2 < 3. \qquad ( 3 )$$
wherein,
αr2 is an angle (unit: °) formed between a normal line at a position of the second reflection surface on which a principal ray of the first light flux is made incident and a normal line of a conjugate surface including the reduction conjugate point.

6. The optical system according to claim 1, satisfying the following formula (4):
$$0. < rt 1 x / rt 1 y < 0.8 \qquad ( 4 )$$
wherein,
rt1x is a partial curvature radius in an x direction of the first transmission surface at the first point through which a principal ray of the first light flux passes, and
rt1y is a partial curvature radius in a y direction of the first transmission surface at the first point through which the principal ray of the first light flux passes.

7. The optical system according to claim 1, satisfying the following formula (5):
$$15 < α i 2 m < 30 \qquad ( 5 )$$
wherein,
αi2m is an incident angle (unit: °) at which a principal ray of the first light flux is made incident on the second reflection surface.

8. The optical system according to claim 1, wherein the optical system is disposed between a reduction conjugate surface formed at a position of the reduction conjugate point and a magnification conjugate surface formed at a position of the magnification conjugate point in the Z direction, and the reduction conjugate surface and the magnification conjugate surface are parallel to each other.

9. The optical system according to claim 1, satisfying the following formula (6):
$$\vert ( SF / V ) \times ( H / D ) \vert > 2.7 \qquad ( 6 )$$
wherein,
D is a distance between the magnification conjugate point and the optical system,
V is a length in a first direction parallel to a vertical direction to the magnification conjugate point perpendicular to the optical axis, of an effective region in which all light rays are projected or imaged on a conjugate surface including the magnification conjugate point,
H is a length in a second direction perpendicular to the vertical direction, of the effective region in which all light rays are projected or imaged on the conjugate surface including the magnification conjugate point, and
SF is a vertical distance from the optical axis to a center of a length of the effective region in the first direction.

10. The optical system according to claim 1, wherein a first footprint region on the second reflection surface of the first light flux on the first transmission surface overlaps a second footprint region on the second reflection surface of a second light flux farthest from the optical axis on the first transmission surface.

11. An optical system having a reduction conjugate point on a reduction side and a magnification conjugate point on a magnification side, and having an intermediate imaging position conjugated with each of the reduction conjugate point and the magnification conjugate point inside, the optical system comprising:
a first sub-optical system including a plurality of lenses arranged along an optical axis in a Z direction, and an aperture stop between two lenses among the plurality of lenses; and
a second sub-optical system disposed closer to the magnification side than the first sub-optical system and including a prism having a plurality of optical surfaces, wherein
the prism includes: as the plurality of optical surfaces,
a first transmission surface located on the reduction side,
a second transmission surface located on the magnification side; and
a reflection surface group including a plurality of reflection surfaces having a first reflection surface and a second reflection surface located between the first transmission surface and the second transmission surface in a Y direction perpendicular to the Z direction, and located in order of an optical path from the first transmission surface to the second transmission surface,
a light flux travels in a YZ surface including the Z direction and the Y direction inside the prism,
the intermediate imaging position of a first light flux closest to the optical axis is disposed between the first transmission surface and the first reflection surface,
the second transmission surface has a shape with a convex surface facing the magnification side, and a reflection surface located on a most magnification side in the reflection surface group has a convex shape with respect to the inside of the prism,
the reduction conjugate point has a rectangular region having a first direction and a second direction, a plane surface including a position where a principal ray of the first light flux in the rectangular region reflects off the first reflection surface and the optical axis of the first sub-optical system is defined as a Y cross section, and a light flux farthest from the optical axis of the first sub-optical system on a line where the Y cross section and the rectangular region intersect is defined as a second light flux, a first footprint region of the first light flux overlaps a second footprint region of the second light flux on the second reflection surface.

12. The optical system according to claim 11, wherein when a position at which the principal ray of the first light flux reflects is defined as Y1, the first reflection surface has a curved surface shape giving positive power at the Y1.

13. The optical system according to claim 12, wherein when a position where a principal ray of the second light flux reflects is defined as Y2, the first reflection surface has a curved surface shape in which power given at the Y2 is smaller than the positive power given at the Y1.

14. The optical system according to claim 13, wherein the first reflection surface has a curved surface shape to which negative power is given at the Y2.

15. The optical system according to claim 12, comprising a third reflection surface on an optical path between the second reflection surface and the second transmission surface, wherein
the second reflection surface has a concave shape with respect to an inside of the prism, and
the third reflection surface is a reflection surface on a most magnification side in the reflection surface group.

16. The optical system according to claim 12, wherein on the Y cross section, the first footprint region is located within a range of a center 70% of the second footprint region.

17. The optical system according to claim 16, wherein on the Y cross section, a size ratio of the second footprint region to the first footprint region is 20% or less.

18. The optical system according to claim 12, further comprising a third reflection surface on an optical path between the second reflection surface and the second transmission surface,
wherein on the third reflection surface, a third footprint region of the first light flux is located closer to the optical axis of the first sub-optical system than a fourth footprint region of the second light flux, and
on the Y cross section, a size ratio of the third footprint region to the fourth footprint region is 20% or less.

19. An image projection apparatus comprising:
the optical system according to claim 1; and
an image forming element configured to generate an image to be projected onto a screen via the optical system.

20. An imaging apparatus comprising:
the optical system according to claim 1; and
an imaging element configured to receive an optical image formed by the optical system and convert the optical image into an electrical image signal.
